(19) United States
(12) Patent Application Publication
(10) Pub. No.: US 2013/0091634 A1
(43) Pub. Date: Apr. 18, 2013

(54) MATTRESS ASSEMBLIES AND RELATED COMPONENTS AND METHODS EMPLOYING MAGNETICALLY-SECURED EDGE-SUPPORT MEMBERS

(71) Applicant: Keith Shearon, Youngsville, NC (US)

(72) Inventor: Keith Shearon, Youngsville, NC (US)

(73) Assignee: NOMACO INC., Zebulon, NC (US)

(21) Appl. No.: 13/283,652

(22) Filed: Oct. 28, 2011

Related U.S. Application Data
(60) Provisional application No. 61/546,336, filed on Oct. 12, 2011.

(51) Int. Cl. A47C 27/08; B23P 11/00; A47C 17/00

(52) U.S. Cl. 5/693; 29/428

(57) ABSTRACT

Embodiments disclosed include mattress assemblies and related components and methods employing magnetically-secured elongated edge-support members. The elongated edge-support members may be employed as side rails and end rails along the length and width of a mattress respectively to provide support along an edge of the mattress as a non-limiting example. Each elongated edge-support member may include elongated edge-support member sections aligned and secured by one or more magnets and magnetic attractive members ready to be assembled into the mattress. The elongated edge-support members may be converted to a second configuration easier to store and transport prior to inclusion in a mattress by removing the elongated edge-support member sections from alignment by pulling apart the one or more magnets and magnetic attractive members and pivoting the elongated edge-support member sections with respect to each other at the connection.

### PRIORITY APPLICATION

The present non-provisional application claims priority from U.S. Provisional Patent Application Ser. No. 61/546,336, filed on Oct. 12, 2011, entitled “Mattress Assemblies and Related Components and Methods Employing Magnetically-Secured Edge-support Members,” which is hereby incorporated herein by reference in its entirety.

### FIELD OF THE DISCLOSURE

The technology of the disclosure relates generally to mattress assemblies, mattresses, and related methods providing support, including edge-support members, which may be employed in bedding and seating applications.

### BACKGROUND

Innerspring assemblies for mattresses or seating structures may be composed of spring coils attached together in a matrix or array. An example of such an assembly (“innerspring”) is illustrated by the mattress 10 of FIG. 1 and provided as part of the mattress 10. The innerspring 12 is comprised of conventional coils 14 arranged in an interconnected matrix to form a flexible core and support surfaces of the mattress 10. Adjacent coils 14 are secured to one another by lower interconnection helical wires 16 and upper interconnection helical wires 18. At a perimeter 20 of the innerspring 12, innerspring coils 14 are also connected to one another by upper and lower border wires 22, 24. Upper and lower border wires 22, 24 are attached to upper and lower end turns of the coils 14 to create a frame 26 for the innerspring 12. The upper and lower border wires 22, 24 may provide firmness for edge support on the perimeter 20 of the innerspring 12 where an individual user may disproportionally place weight on the innerspring 12, such as during mounting onto and dismounting from the mattress assembly 10. The mattress 10 may be disposed on top of a base 28 to provide base support.

With reference to the mattress 10 in FIG. 1, with regard to an edge 30 of the innerspring 12, there are some general considerations regarding construction and manufacture. In normal use, the edge 30 is subjected to greater weight in the form of compression forces than an interior 32 of the innerspring 12 due to the common practice of sitting on the edge 30 of the mattress 10. The coils 14 located proximate to the edge 30 of the innerspring 12 are subjected to concentrated weight (loads) as opposed to coils 14 located in the interior 32. To provide further perimeter structure and edge-support for the innerspring 12, edge-support members 34 may be disposed around the coils 14 proximate to the edge 30 of the innerspring 12 between the base 28 and the upper and lower border wires 22, 24. The edge-support members 34 may be extruded from polymer-foam, for example. One or more padding material layer(s) 36 may be disposed on top of the innerspring 12, and then upholstery 38 is placed around the padding material layer(s) 36, innerspring 12, the edge-support members 34, and base 28 to form the mattress 10 in its fully assembled state. This mattress structure in FIG. 1 may also be provided for other types of innersprings, including pocketed coils.

The dimensions of the edge-support members 34 must be manufactured to be compatible with the size of the innerspring 12. For example, the length of the edge-support members 34 must be properly sized to extend along the edge 30 of the innerspring 12 without extending beyond the corner 39 such that the edge-support members 34 can be properly encased within the upholstery 38, as shown in FIG. 1. Further, the edge-support members 34 should be sufficiently engaged with the innerspring 12 to provide stability and a uniform sleep surface for the mattress 10 between the edge 30 and the interior 32.

The edge-support members 34 may be manufactured by a different company from the mattress assembler. In this regard, the edge-support members 34 are stored after manufacturing and then transported to a mattress assembler for assembly into a mattress 10. The storage and shipping expense for the edge-support members 34 is influenced by the volume consumed by the edge-support members 34 in shipping packaging or containers. It is generally more expensive to store and transport items that do not have a compact shape. The volume consumed by the edge-support members 34 in storage and during transportation may be reduced by bending the edge-support members 34 into shorter sections, but at the risk of the edge-support members 34 being damaged.

### SUMMARY OF THE DETAILED DESCRIPTION

Embodiments disclosed include mattress assemblies and related components and methods employing magnetically-secured elongated edge-support members. The elongated edge-support members may be employed as side rails and end rails along the length and width of a mattress respectively to provide support along an edge of the mattress as a non-limiting example. Each elongated edge-support member may include elongated edge-support member sections aligned and secured by one or more magnets and magnetic attractive members ready to be assembled into the mattress. The elongated edge-support members may be converted to a second configuration easier to store and transport prior to inclusion in a mattress by removing the elongated edge-support member sections from alignment by pulling apart the one or more magnets and magnetic attractive members and pivoting the elongated edge-support member sections with respect to each other at the connection.

In this regard in one embodiment, an elongated edge-support member for a mattress assembly is provided. The elongated edge-support member may include, as non-limiting examples, a first elongated edge-support member section, a second elongated edge-support member section, at least one magnet, at least one magnetic attractive member, and a first connection. The first elongated edge-support member section may include a first end and a second end disposed along a first longitudinal axis. The first end may include a first end surface at least partially facing the first longitudinal axis. The second elongated edge-support member section may include a first end and a second end disposed along a second longitudinal axis. The second end may include a second end surface at least partially facing the second longitudinal axis. The at least one magnet may be disposed in the first end of the first elongated edge-support member section. The at least one magnetic attractive member may be disposed in a second end of the second elongated edge-support member section. The first connection may connect a portion of the first end of the first elongated edge-support member section and a portion of the second end of the second elongated edge-support member section. In a first configuration, an attraction force between the at least one magnet and the at least one magnetic attractive member may align the first end surface with the second end surface. The attraction force may also align the first elongated edge-support member section and the second elongated edge-support member section along the first longitudinal axis.

In another embodiment, a method for creating and installing an elongated edge-support member for a mattress assembly is disclosed. The method may include defining a first elongated edge-support member section and a second elongated edge-support member section within an elongated member. The first elongated edge-support member section may include a first end and a second end disposed along a first longitudinal axis. The second elongated edge-support member section may include a first end and a second end disposed along a second longitudinal axis. The method may also include removing material between the first end of the first elongated edge-support member section and the second end of the second elongated edge-support member section. A first end surface of the first end of the first elongated edge-support member section may be formed as part of the material removal. A second end surface of the second end of the second elongated edge-support member section, a first connection between a portion of the first end of the first elongated edge-support member section, and a portion of the second end of the second elongated edge-support member section may also be formed.

The method may also include disposing at least one magnet in the first end of the first elongated edge-support member section. At least one magnetic attractive member may be disposed in the second end of the second elongated edge-support member section. The method may also include aligning the first elongated edge-support member section and the second elongated edge-support member section in a first configuration. This may occur by aligning the first end surface of the first elongated edge-support member section and the second end surface of the second elongated edge-support member section with an attraction force disposed between the at least one magnet and the at least one magnetic attractive member.

In another embodiment, a mattress assembly is provided. This mattress assembly may include, as non-limiting examples, a mattress core having an outer perimeter and a sleep surface disposed inside the outer perimeter, and an elongated edge-support member disposed along the outer perimeter of the mattress core. The elongated edge-support member may include a first elongated edge-support member section, a second elongated edge-support member section, at least one magnet, at least one magnetic attractive member, and a first connection. The first elongated edge-support member section may include a first end and a second end disposed along a first longitudinal axis. The first end may include a first end surface at least partially facing the first longitudinal axis. The second elongated edge-support member section may include a first end and a second end disposed along a second longitudinal axis. The second end may include a second end surface at least partially facing the second longitudinal axis. The at least one magnet may be disposed in the first end of the first elongated edge-support member section. The at least one magnetic attractive member may be disposed in second end of the second elongated edge-support member section. The first connection may exist between a portion of the first end of the first elongated edge-support member section and a portion of the second end of the second elongated edge-support member section. In a first configuration, an attraction force may be disposed between the at least one magnet and the at least one magnetic attractive member. The attraction force may align the first end surface with the second end surface. The attraction force may also align the first elongated edge-support member section and the second elongated edge-support member section along the first longitudinal axis.

The aforementioned elongated edge-support members may provide edge-support compatible with various mattress types, for example, innerspring coil mattress cores or air bladder mattress cores having varying widths and lengths forming the mattress core perimeter. The elongated edge-support members also provide support that may be compatible with different types of mattress cores that may have variations in perimeter widths and lengths between the different types of mattress cores. Furthermore, the elongated edge-support members may be more compact for storage and transport.

### BRIEF DESCRIPTION OF THE DRAWINGS

FIG. 1 is a perspective partial cutaway view of a mattress in the prior art;

FIG. 2A is an exemplary mattress employing an elongated edge-support member in a first configuration;

FIG. 2B is a side cutaway view of the mattress of FIG. 2A depicting a magnet disposed in the elongated edge-support member;

FIG. 2C is a side cutaway view of the mattress of FIG. 2A depicting a magnetic attractive member disposed in the elongated edge-support member;

FIG. 3 is a perspective view of the elongated edge-support member of FIG. 2A in the first configuration;

FIG. 4 is a side view of the elongated edge-support member of FIG. 2A in the first configuration depicting detail of a first connection and a second connection;

FIG. 5 is an exploded side view of the elongated edge-support member of FIG. 2A which is not in the first configuration;

FIG. 6A is a side view of a magnet of the elongated edge-support member of FIG. 2A;

FIG. 6B is an axial view of the magnet of FIG. 6A;

FIG. 6C is a side view of a magnetic attractive member of the elongated edge-support member of FIG. 4;

FIG. 6D is an axial view of the magnetic attractive member of FIG. 6C;

FIG. 7A is a side view of an exemplary attachment device that can be used to dispose the magnet of FIGS. 6A through 6B and/or the magnetic attractive member of FIGS. 6C through 6D in the elongated edge-support member of FIG. 2B and FIG. 2C respectively;

FIG. 7B is a bottom view of the exemplary attachment device of FIG. 7A;

FIG. 7C is a top view of the exemplary attachment device of FIG. 7A;

FIG. 8 is a perspective view of the elongated edge-support member of FIG. 2A which is not in the first configuration;

FIG. 9A is a side view of the elongated edge-support member of FIG. 2A which is in the second configuration;

FIG. 9B is a axial view of the elongated edge-support member of FIG. 2A which is in the second configuration;

FIG. 10 is a flowchart diagram illustrating an exemplary method that may create the elongated edge-support member of FIG. 2A;

FIG. 11 is a perspective view of an elongated member of FIG. 2A with first and second elongated edge-support member sections defined;

FIG. 12 is a perspective view of the elongated member of FIG. 11 with material removed between a first end of the first elongated edge-support member section and a second end of the second elongated edge-support member section;

FIG. 13 is a side view of the elongated member of FIG. 12 with the magnet being disposed in the first end of the first elongated edge-support member section;

FIG. 14A is a side view of a portion of the magnet of FIG. 13 being disposed into an attachment device;

FIG. 14B is a bottom view of the attachment device of FIG. 14A;

FIG. 14C is a top view of the attachment device of FIG. 14A;

FIG. 15 is a side view of the elongated member of FIG. 13 with a magnetic attractive member being disposed in the second end of the second elongated edge-support member section;

FIG. 16A is a side view of a portion of the magnetic attractive member of FIG. 15 being inserted into an attachment device;

FIG. 16B is a bottom view of the attachment device of FIG. 16A;

FIG. 16C is a top view of the attachment device of FIG. 16A;

FIG. 17 is a side view of the first elongated edge-support member section and the second elongated edge-support member section of the elongated member of FIG. 15 aligned in the first configuration;

FIG. 18 is a side view of the elongated member of FIG. 17 with a moment M₁ applied to a first connection to remove the second elongated edge-support member section from alignment with respect to the first longitudinal axis A₁ to create the second configuration;

FIG. 19 is a side view of the elongated member of FIG. 18 with the third elongated edge-support section defined;

FIG. 20 is a side view of the elongated member of FIG. 18 with material removed between a first end of the second elongated edge-support member section and a second end of the third elongated edge-support member section;

FIG. 21 is a side view of the elongated member of FIG. 20 with a second magnet being disposed in the first end of the second elongated edge-support member section;

FIG. 22 is a side view of the elongated member of FIG. 21 with a second magnetic attractive member being disposed in the second end of the third elongated edge-support member section;

FIG. 23 is a side view of the second elongated edge-support member section and the third elongated edge-support member section of the elongated member of FIG. 22 which is aligned in the first configuration;

FIG. 24 is a side view of the elongated member of FIG. 23 with a moment M₂ applied to a second connection to remove the third elongated edge-support member section from alignment with respect to the second longitudinal axis A₁ to create the second configuration;

FIG. 25A is an axial view of an alternative embodiment of an elongated member in the second configuration;

FIG. 25B is a perspective view of the alternative embodiment of the elongated member of FIG. 25 in transition to the first configuration;

FIG. 25C is a perspective view of the alternative embodiment of the elongated member of FIG. 25A in the first configuration;

FIG. 26 is a perspective view of an exemplary mattress assembly which may include the elongated edge-support member of FIG. 2A as a side rail and an elongated edge-support member as an end rail;

FIG. 27A is a perspective view of an alternative embodiment of the mattress of FIG. 2A depicting at least one air bladder mattress core system instead of an innerspring mattress core; and

FIG. 27B is a side cutaway view of the mattress of FIG. 27A depicting the at least one air bladder mattress core system and a center wall support.

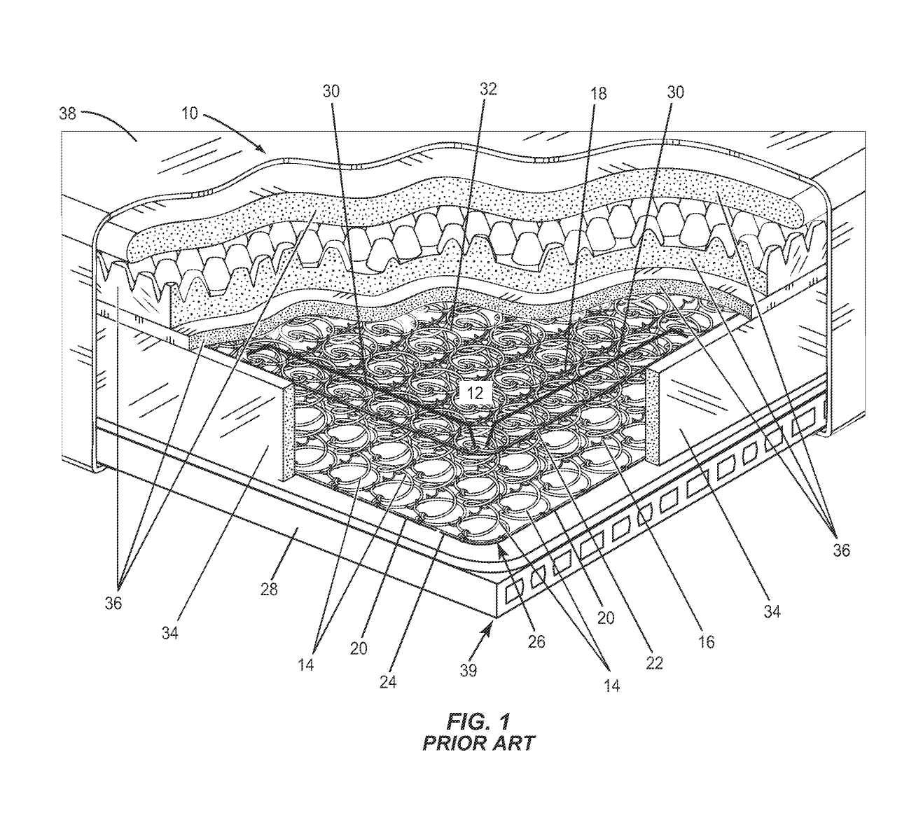

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed include mattress assemblies and related components and methods employing magnetically-secured elongated edge-support members. The elongated edge-support members may be employed as side rails and end rails along the length and width of a mattress respectively to provide support along an edge of the mattress as a non-limiting example. Each elongated edge-support member may include elongated edge-support member sections aligned and secured by one or more magnets and magnetic attractive members ready to be assembled into the mattress. The elongated edge-support members may be converted to a second configuration easier to store and transport prior to inclusion in a mattress by removing the elongated edge-support member sections from alignment by pulling apart the one or more magnets and magnetic attractive members and pivoting the elongated edge-support member sections with respect to each other at the connection.

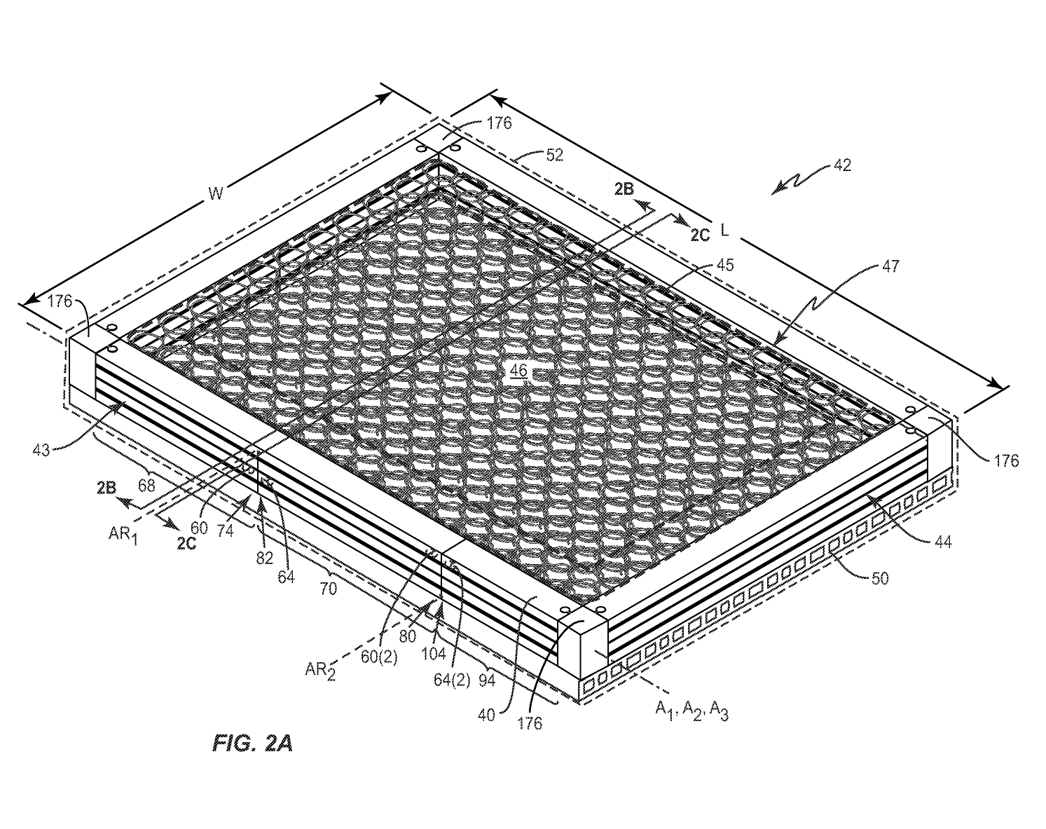

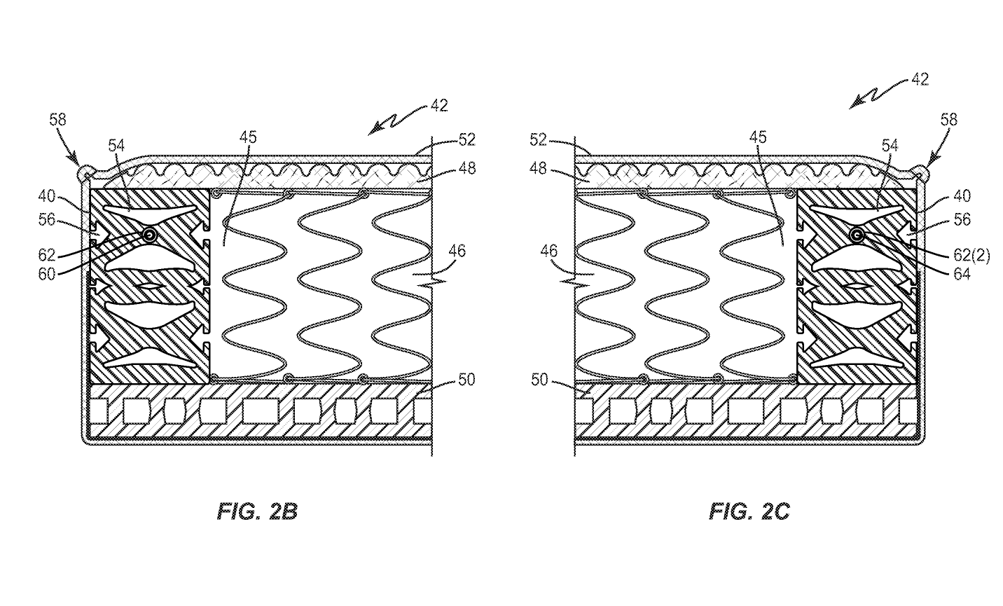

In this regard, FIGS. 2A through 2C illustrate a partial cross-section of an exemplary elongated edge-support member 40 of an exemplary mattress assembly 42. In this embodiment, the elongated edge-support member 40 serves as a side rail 43 along a length L of the mattress. FIG. 2A also depicts an end rail 44 along a width W of the mattress assembly 42. The elongated edge-support member 40 may be disposed along an outer perimeter 45 of a mattress core 47 and may be disposed between a layer of padding material 48 and a base 50. In this embodiment the mattress core 47 is an innerspring 46. The base 50 may be also known as a foam deck. The mattress assembly 42 may include upholstery 52 to form an exterior surface that surrounds the other components.

As shown in FIG. 2B, the elongated edge-support member 40 may include an orifice 54 and/or groove 56 that may be disposed longitudinally through the elongated edge-support member 40. The orifice 54 and groove 56 may permit the elongated edge-support member 40 to be more flexible when a user sits on the edge 58 of the mattress assembly 42.

The elongated edge-support member 40 may be manufactured by a different company from the mattress assembler. In this regard, the elongated edge-support member 40 can be stored after manufacturing and then transported to a mattress assembler for assembly into a mattress 10. The storage and shipping expense for the elongated edge-support member 40 is influenced by the volume consumed by the elongated edge-support member 40 in shipping packaging or containers. It may be more expensive to store and transport items that do not have a compact shape. The volume consumed by the elongated edge-support member 40 in storage and during shipping may be reduced by bending the elongated edge-support member 40 into shorter sections, but at the risk of the elongated edge-support member 40 being damaged.

In this regard with reference to FIGS. 2A-2C, at least one magnet 60 may be included as part of the elongated edge-support member 40 to provide longitudinal strength to the elongated edge-support member 40 when it is assembled as part of the mattress assembly 42. The magnet 60 may be attached to the elongated edge-support member 40 with an attachment device 62. The magnet 60 provides longitudinal strength to the elongated edge-support member 40 by providing an attraction force with a magnetic attractive member 64. As shown in FIG. 2C, magnetic attractive member 64 may be attached to the mattress assembly 42 with a second attachment device 62(2).

There are several non-limiting benefits to providing the magnet 60 and the magnetic attractive member 64 as part of the elongated edge-support member 40. For example, providing the magnet 60 and the magnetic attractive member 64 as part of the elongated edge-support member 40 can assist assembling and securing shorter sections of the elongated edge-support member 40 together to form a longer member to be included as part of a mattress assembly, such as mattress assembly 42. Also, the elongated edge-support member 40 may be designed in sections having specific standardized lengths to allow for the use of standardized containers and storage areas to reduce wasted volume and associated expense during storage and/or shipment. Further, providing the magnet 60 and the magnetic attractive member 64 as part of the elongated edge-support member 40 may preclude the use of glue or other adhesive or cohesive means from being required to secure the magnet 60 and the magnetic attractive member 64 together. Further, handling and quickly assembling the components of the elongated edge-support member 40 may be simplified, more convenient, and faster by providing the magnet 60 and the magnetic attractive member 64 as part of the elongated edge-support member 40.

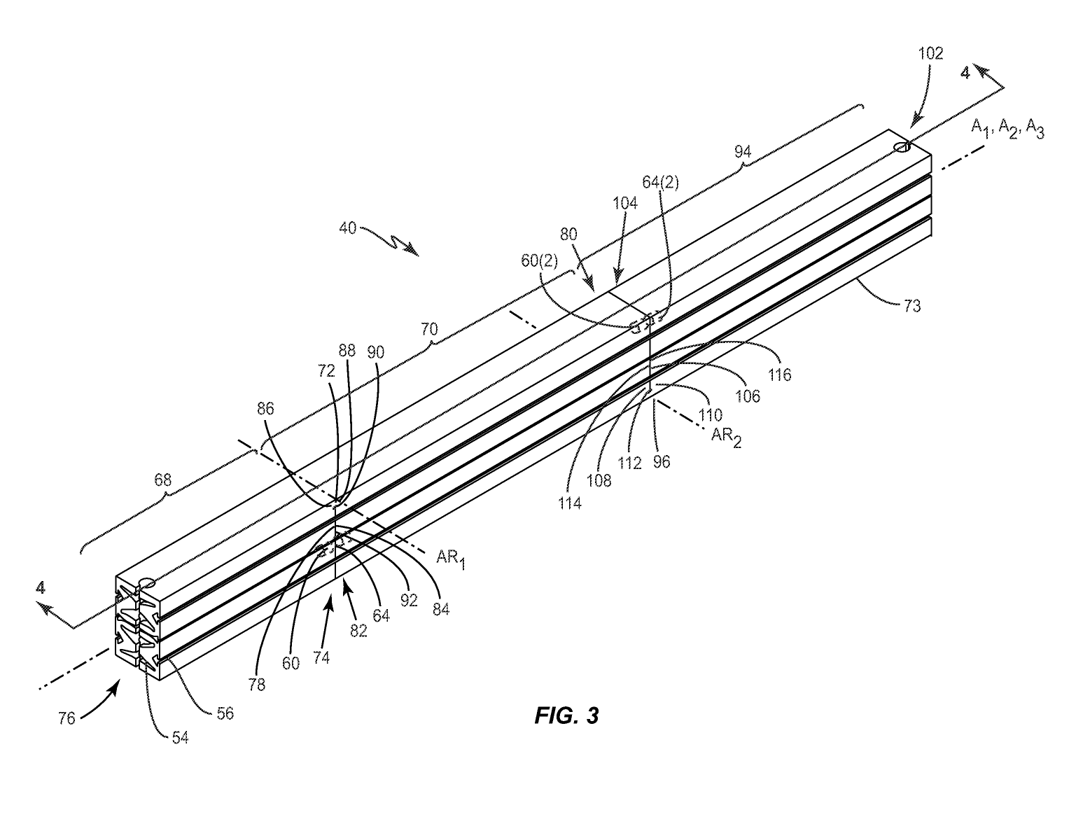

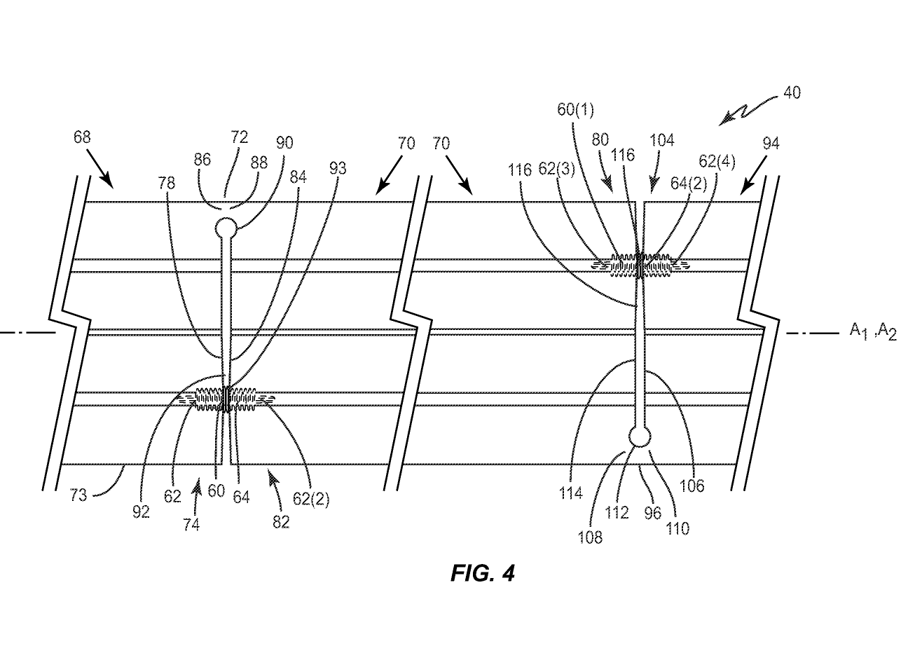

FIGS. 3 and 4 depict the elongated edge-support member 40 in a first configuration consistent with being assembled into the mattress assembly 42. The elongated edge-support member 40 may include a first elongated edge-support member section 68, a second elongated edge-support member section 70, a first connection 72, a magnet 60, and a magnetic attractive member 64. The first elongated edge-support member section 68 and the second elongated edge-support member section 70 are portions of an elongated member 73. The elongated member 73 may be made of flexible, strong, and resilient material, for example, thermoplastic foam or polymer foam. As shown earlier, the elongated member 73 of the elongated edge-support member 40 may include the orifice 54 and/or the groove 56 that may be disposed longitudinally through the elongated edge-support member 40 to provide additional flexibility.

The first elongated edge-support member section 68 may include a first end 74 and a second end 76 disposed along a first longitudinal axis A₁. The first end 74 may include a first end surface 78 that may at least partially face the first longitudinal axis A₁. The first end surface 78 may partially face the first longitudinal axis A₁ to enable the magnet 60 and the magnetic attractive member 64 to better provide longitudinal strength.

The second elongated edge-support member section 70 may include a first end 80, and a second end 82 disposed along a second longitudinal axis A₂. The second end 82 of the second elongated edge-support member section 70 may include a second end surface 84 at least partially facing the second longitudinal axis A₂.

The first connection 72 may connect a portion 86 of the first end 74 of the first elongated edge-support member section 68 to a portion 88 of the second end 82 of the second elongated edge-support member section 70. The first connection 72 may include a rounded surface 90 in contact with the first end surface 78 of the first elongated edge-support member section 68 and the second end surface 84 of the second elongated edge-support member section 70. The first end surface 78 of the first elongated edge-support member section 68 and the second end surface 84 of the second elongated edge-support member section 70 may be separated by a gap 92. The gap 92 enables the magnet 60 and magnetic attractive member 64 to be disposed in the elongated edge-support member 40.

With continued reference to FIG. 4, the at least one magnet 60 may be disposed in the first end 74 of the first elongated edge-support member section 68. The at least one magnet 60 may be contained within at least one attachment device 62. At least one magnetic attractive member 64 may be disposed in second end 82 of the second elongated edge-support member section 70. The at least one magnetic attractive member 64 may be contained within a second attachment device 62(2). In the first configuration, an attraction force 93 disposed between the magnet 60 and the magnetic attractive member 64 aligns the first end surface 78 with the second end surface 84, and aligns the first elongated edge-support member section 68 and the second elongated edge-support member section 70 along the first longitudinal axis A₁.

With continuing reference to FIGS. 3 and 4, the elongated edge-support member 40 may also include a third elongated edge-support member section 94, a second connection 96, the at least one second magnet 60(2), and the at least one second magnetic attractive member 64(2). The third elongated edge-support member section 94 may be included as part of the elongated member 73. The third elongated edge-support member section 94 may include a first end 102 and a second end 104 disposed along a third longitudinal axis A₃. The second end 104 may include a second end surface 106 at least partially facing the third longitudinal axis A₃.

The second connection 96 may connect a portion 108 of the first end 80 of the second elongated edge-support member section 70 to a portion 110 of the second end 104 of the third elongated edge-support member section 94. The second connection 96 may include a second rounded surface 112 in contact with a first end surface 114 of the second elongated edge-support member section 70 and the second end surface 106 of the third elongated edge-support member section 94. The first end surface 114 of the second elongated edge-support member section 70 and the second end surface 106 of the third elongated edge-support member section 94 may be separated by a second gap 116. The second gap 116 enables the second magnet 60(2) and at least one second magnetic attractive member 64(2) to be disposed in the elongated edge-support member 40.

The second magnet 60(2) may be disposed in the first end 80 of the second elongated edge-support member section 70. The second magnet 60(2) may be contained within at least one third attachment device 62(3). The second magnetic attractive member 64(2) may be disposed in second end 104 of the third elongated edge-support member section 94. The second magnetic attractive member 64(2) may be contained within a fourth attachment device 62(4). In the first configuration, a second attraction force 118 disposed between the at least one second magnet 60(2) and the at least one second magnetic attractive member 64(2) aligns the first end surface 114 of the second elongated edge-support member section 70 with the second end surface 106 of the third elongated edge-support member section 94, and aligns the second elongated edge-support member section 70 and the third elongated edge-support member section 94 along the second longitudinal axis A₂.

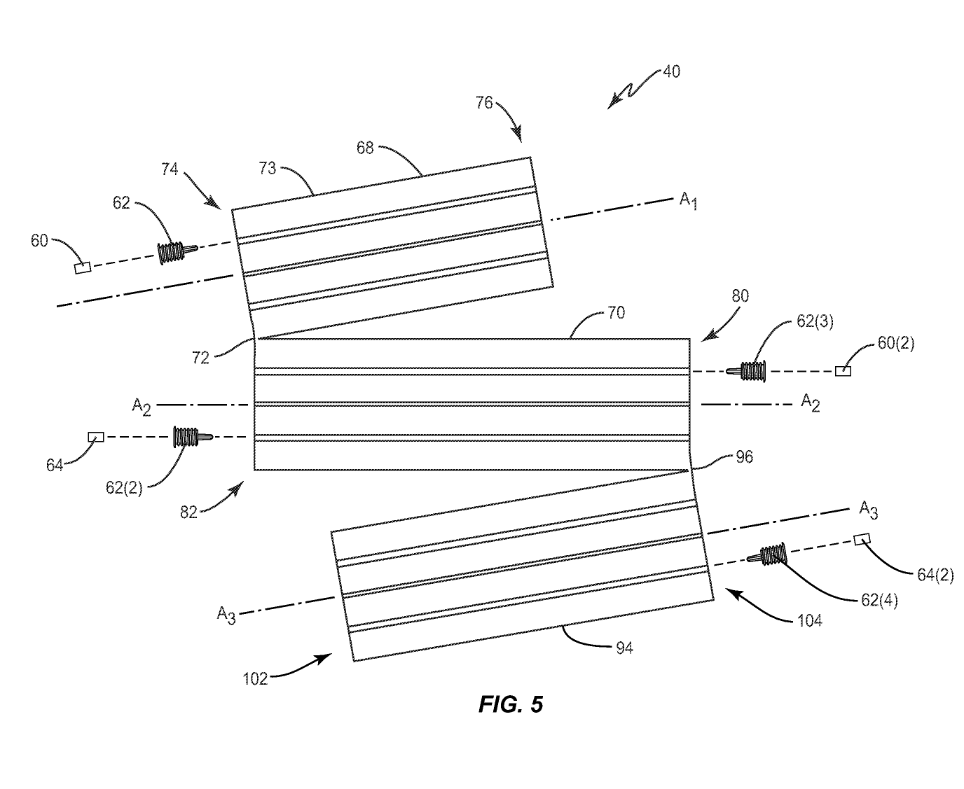

FIG. 5 is an exploded view from a side of the elongated edge-support member 40 of FIG. 2A pivoted at the first connection 72 and the second connection 96 to better depict the arrangement of components. The magnet 60 may be disposed within the first end 74 of the first elongated edge-support member section 68. The magnet 60 may also be contained within the attachment device 62. The magnetic attractive member 64 may be disposed within the second end 82 of the second elongated edge-support member section 70. The magnetic attractive member 64 may also be contained within the second attachment device 62(2). The second magnet 60(2) may be disposed within the first end 80 of the second elongated edge-support member section 70. The second magnet 60(2) may also be contained within the third attachment device 62(3). The second magnetic attractive member 64(2) may be disposed within the second end 104 of the third elongated edge-support member section 94. The second magnetic attractive member 64(2) may also be contained within the fourth member attachment device 62(4).

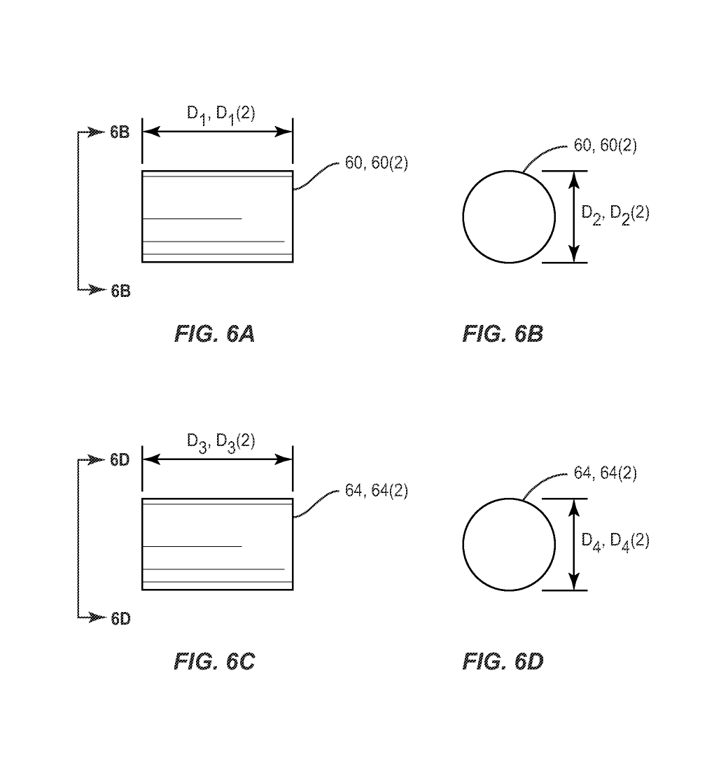

FIGS. 6A and 6B are a view from the side and an axial view of the magnet 60 and second magnet 60(2). The magnet 60 may have a cylindrical shape having a height of D₁ and a diameter D₂. The second magnet 60(2) may also have a cylindrical shape having a height D₁(2) and diameter D₂(2). The heights D₁ and D₁(2) and diameter D₂ and D₂(2) may generally be sized according to the magnet material and attractive force needed. The heights D₁ and D₁(2) may generally be in the range of 1/10-inches to ⅞-inches, although height dimensions outside this range may also be used. The diameters D₂ and D₂(2) may generally be in the range of 3/16-inches to ⅞-inches, although dimensions of diameters D₂ and D₂(2) outside this range may also be used. The magnet 60 and second magnet 60(2) may be made of one or more materials which produce a persistent magnetic field. The one or more materials may include any commercially available materials, for example, neodymium, ceramic materials, samarium cobalt, and/or alnico.

FIGS. 6C and 6D are a view from the side and an axial view of the magnetic attractive member 64 and second magnetic attractive member 64(2). The magnetic attractive member 64 may have a cylindrical shape having a height of D₃ and having a diameter D₄. The second magnetic attractive member 64(2) may also have a cylindrical shape having a height of D₃(2) and a diameter of D₄(2). The height D₃ and D₃(2) and diameter D₄ and D₄(2) may generally be sized according to the material and the attractive force needed. The height D₃ and D₃(2) may generally be in the range of 1/10-inches to ⅞-inches, although height dimensions outside this range may also be used. The diameter D₄ and D₄(2) may generally be in the range of 3/16-inches to ⅞-inches, although dimensions of diameter D₄ and D₄(2) outside this range may also be used. The magnetic attractive member 64 and the second magnetic attractive member 64(2) may be made of one or more materials which are attracted to the magnet 60 and the second magnet 60(2) respectively. The one or more materials may include ferromagnetic materials, for example, a ferrous material, iron, nickel, or cobalt. Moreover, the magnetic attractive member 64 and the second magnetic attractive member 64(2) may be made of one or more materials which may produce a persistent magnetic field. The one or more materials may include any commercially available materials, for example, neodymium, ceramic materials, samarium cobalt, and/or alnico.

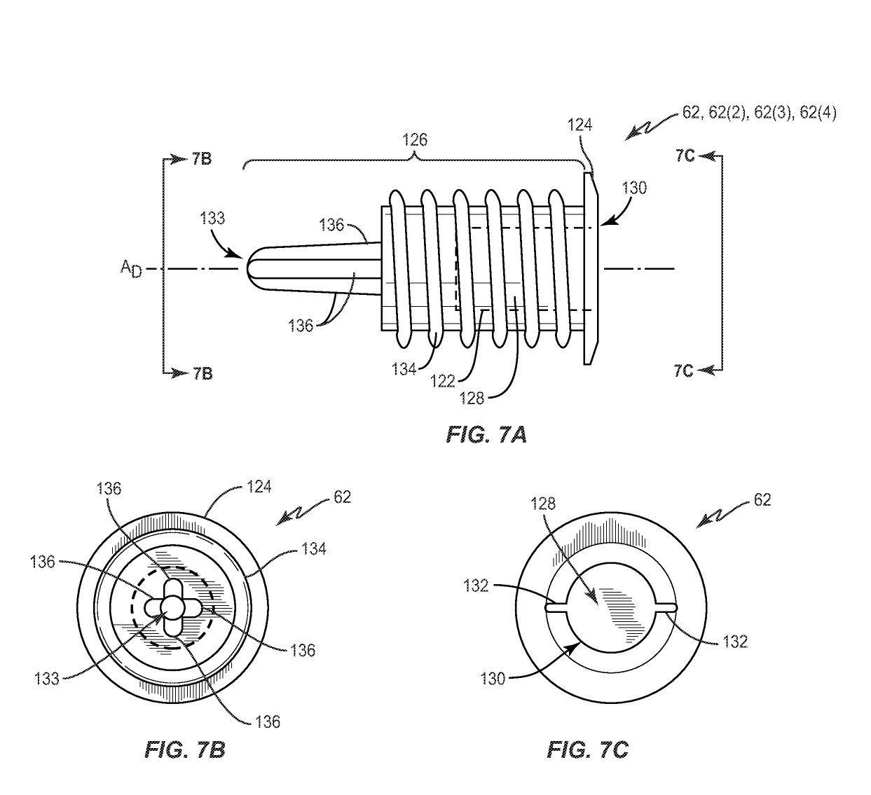

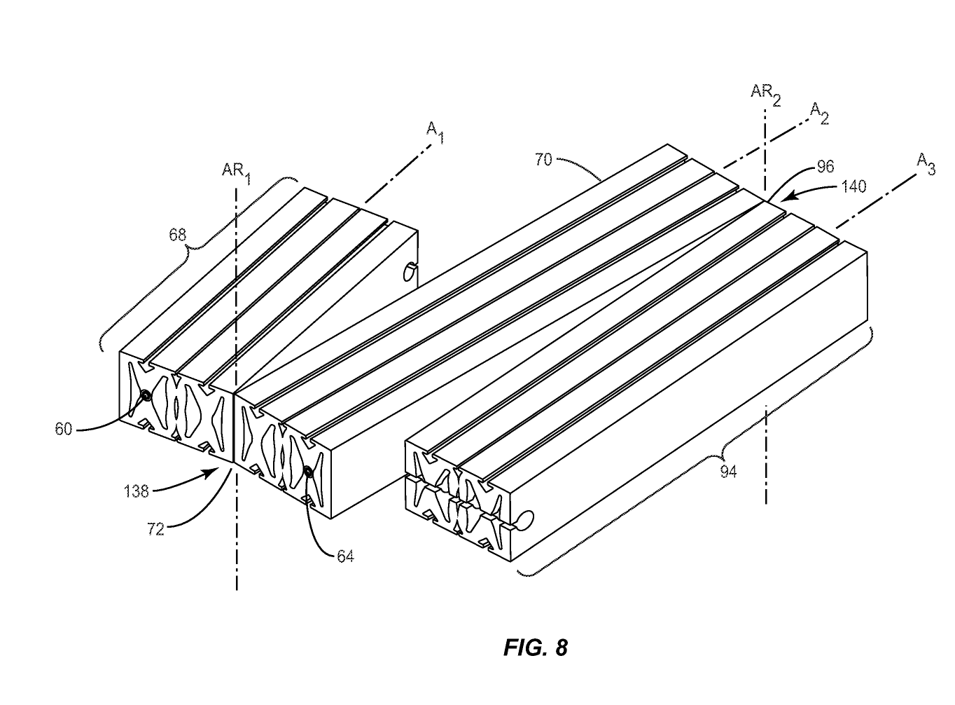

To provide more detail on the attachment device 62 discussed above in FIGS. 2B, 2C, 4 and 5, FIGS. 7A through 7C are provided. FIGS. 7A through 7C depict an exemplary attachment device 62. The attachment device 62 may contain either the magnet 60 or magnetic attractive member 64, and may serve to attach the magnet 60 or magnetic attractive member 64 to the remainder of the elongated edge-support member 40. The attachment device 62 may include an enclosure 122, a head 124, and a shank 126. The enclosure 122 forms an internal cavity 128 configured to contain at least a portion of the magnet 60 or the magnetic attractive member 64. The head 124 may include an insertion orifice 130 and one or more fastener interface surfaces 132. The insertion orifice 130 may be configured to allow at least a portion of the magnet 60 to enter the internal cavity 128. The fastener interface surfaces 132 may be configured to interface with a fastening device (not shown), for example, a screwdriver, to attach the attachment device 62 to the remainder of the elongated edge-support member 40. The fastener interface surfaces 132 may be configured to receive torque from the fastening device.

The shank 126 may extend from the head 124 to a distal end 133 of the attachment device 62 along a device longitudinal axis A_{D}. The shank 126 may include an exterior helical thread 134 disposed in a spiral around the device longitudinal axis A_{D}. The shank 126 may be disposed, for example, within the first end 74 of the first elongated edge-support member section 68, the first end 80 or second end 82 of the second elongated edge-support member section 70, and/or the second end 104 of the third elongated edge-support member section 94. The shank 126 may have a tapered shape to better enter the elongated member 73 without a pre-made hole. However, the shank 126 may alternatively be a non-tapered shape to reduce cost. The attachment device 62 may include radial protrusions 136 attached to the distal end 133 of the shank 126. The radial protrusions 136 may allow for accurate position alignment of the attachment device 62 with respect to the elongated member 73 and ease of installation. The attachment device 62 may be made of a strong resilient material, for example, plastic or metal.

FIG. 8 shows details of the first connection 72 and the second connection 96. The first connection 72 between the first elongated edge-support member section 68 and the second elongated edge-support member section 70 may include a hinge 138 including a first axis of rotation AR₁. The hinge 138 may restrict the first elongated edge-support member section 68 to rotational positions relative to the second elongated edge-support member section 70 about the first axis of rotation AR₁. The hinge 138 may be a living hinge. The living hinge is a thin flexible web of material formed from the elongated member 73 that joins the first elongated edge-support member section 68 and the second elongated edge-support member section 70 together. The advantage to using the living hinge is to simplify and reduce the cost of manufacturing.

The second connection 96 between the second elongated edge-support member section 70 and the third elongated edge-support member section 94 may include a second hinge 140 including a second axis of rotation AR₂. The second hinge 140 may restrict the third elongated edge-support member section 94 to second rotational positions relative to the second elongated edge-support member section 70 about the second axis of rotation AR₂. The second hinge 140 may be a living hinge. The living hinge serving as the second hinge 140 is a thin flexible web of material formed from the elongated member 73 that joins the second elongated edge-support member section 70 and the third elongated edge-support member section 94 together. The advantage to using the living hinge is to simplify and reduce the cost of manufacturing.

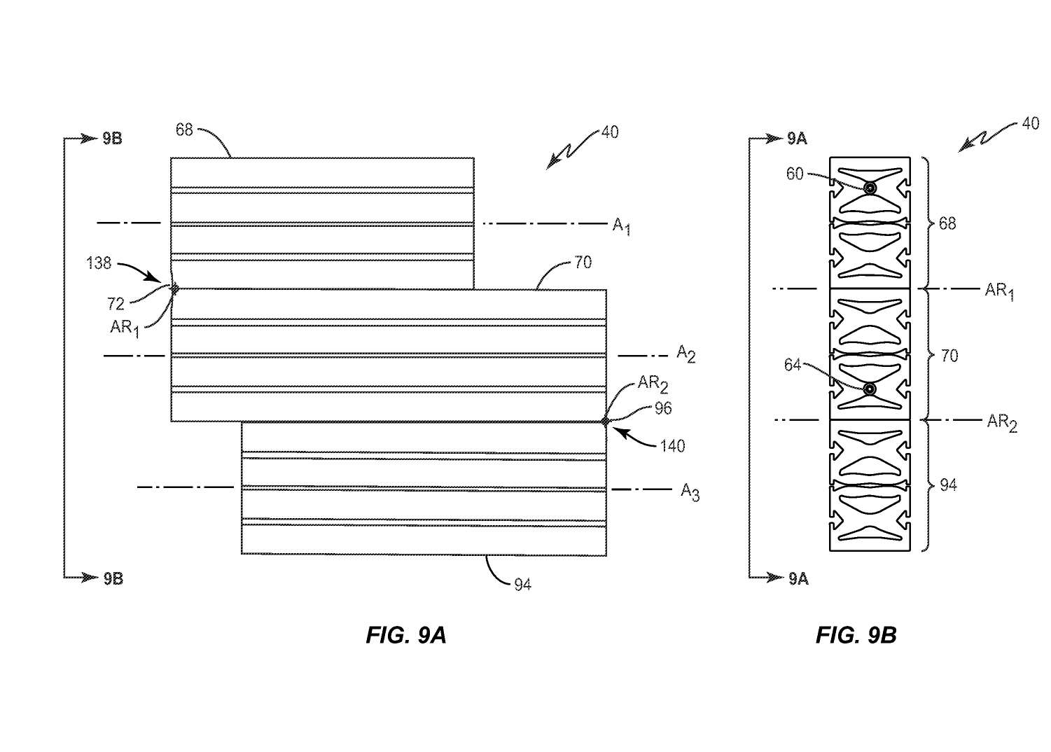

FIGS. 9A and 9B depict the elongated edge-support member 40 in the second configuration which is compact whereby sections are folded on top of each other. This second configuration may be provided for storage and/or transportation. The first elongated edge-support member section 68 may be rotated about the first axis of rotation AR₁ to a rotational position relative to the second elongated edge-support member section 70 wherein the second elongated edge-support member section 70 may not be in alignment with the first longitudinal axis A₁ and the first elongated edge-support member section 68 may not be in alignment with the second longitudinal axis A₂. The first longitudinal axis A₁ may also be parallel with the second longitudinal axis A₂ in the second configuration. The third elongated edge-support member section 94 may be rotated about the second axis of rotation AR₂ to a second rotational position relative to the second elongated edge-support member section 70 wherein the third elongated edge-support member section 94 may not be in alignment with the second longitudinal axis A₂. The third longitudinal axis A₃ may be parallel with the second longitudinal axis A₂. The second configuration may enable the elongated edge-support member 40 to be better situated for storage and/or transport before final assembly into the mattress assembly 42 because it may only be as long as the second elongated edge-support member section 70.

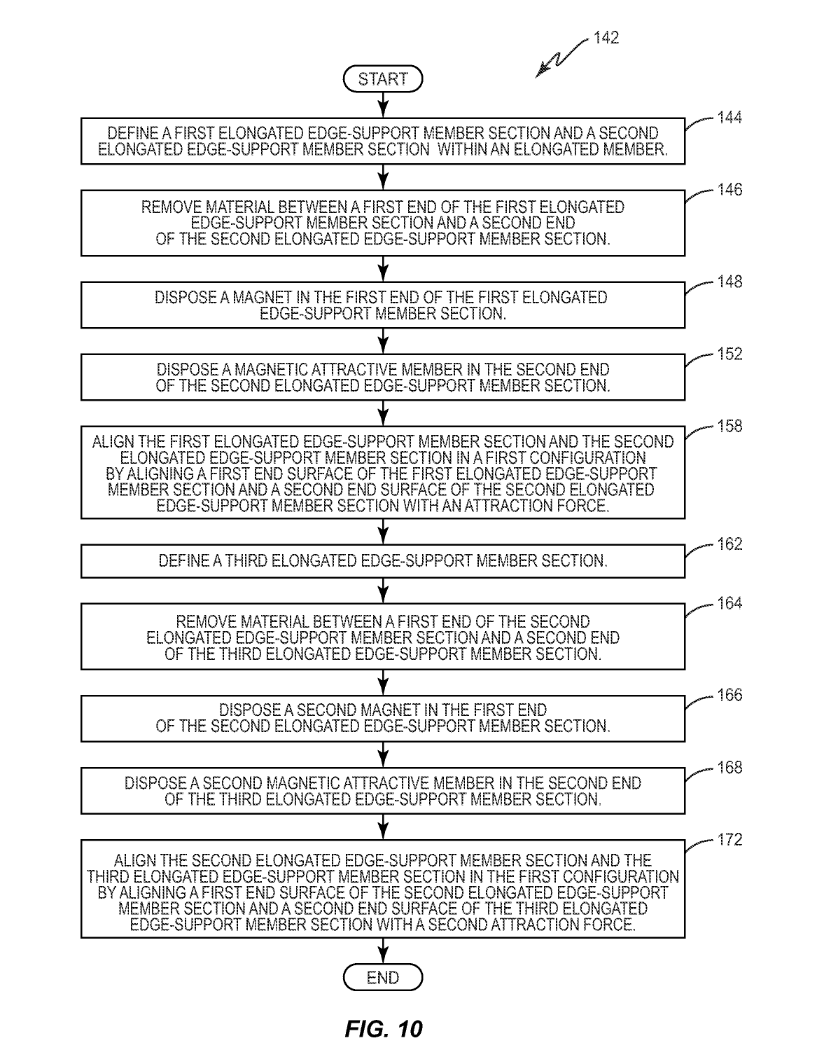

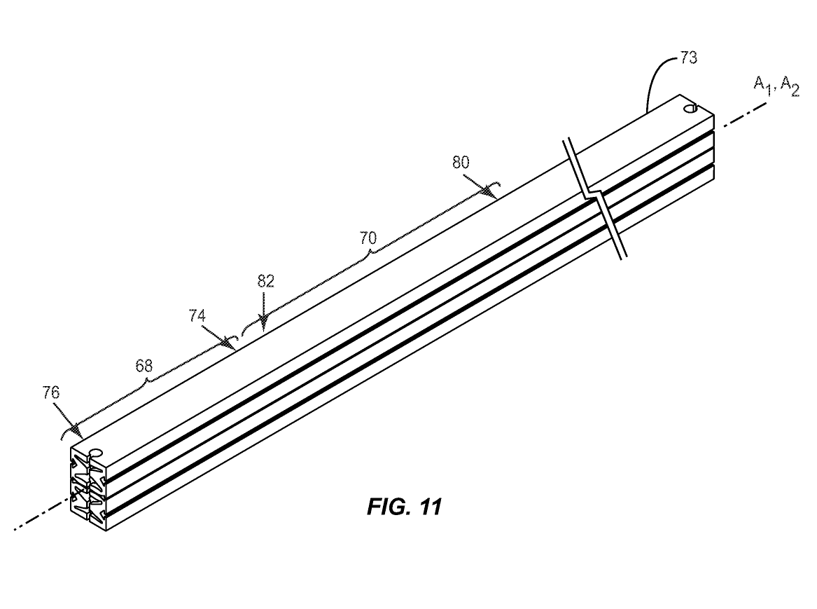

When the elongated edge-support member 40 is ready for inclusion in a mattress assembly 42, the elongated edge-support member 40 is prepared in the first configuration described above where the first, the second, and the third elongated edge-support member sections 68, 70, 94 are aligned. In this regard, FIG. 10 depicts an exemplary method 142 of creating and installing an elongated edge-support member for a mattress assembly as depicted in FIGS. 11 to 23. FIG. 11 depicts the first step of the method 142, which may be comprised of defining the first elongated edge-support member section 68 and the second elongated edge-support member section 70 within the elongated member 73 (step 144 in FIG. 10). The first elongated edge-support member section 68 may include the first end 74 and the second end 76 disposed along the first longitudinal axis A₁. The second elongated edge-support member section 70 may include the first end 80 and the second end 82 disposed along a second longitudinal axis A₂. The defining may include measuring correct lengths for the first elongated edge-support member section 68 and the second elongated edge-support member section 70.

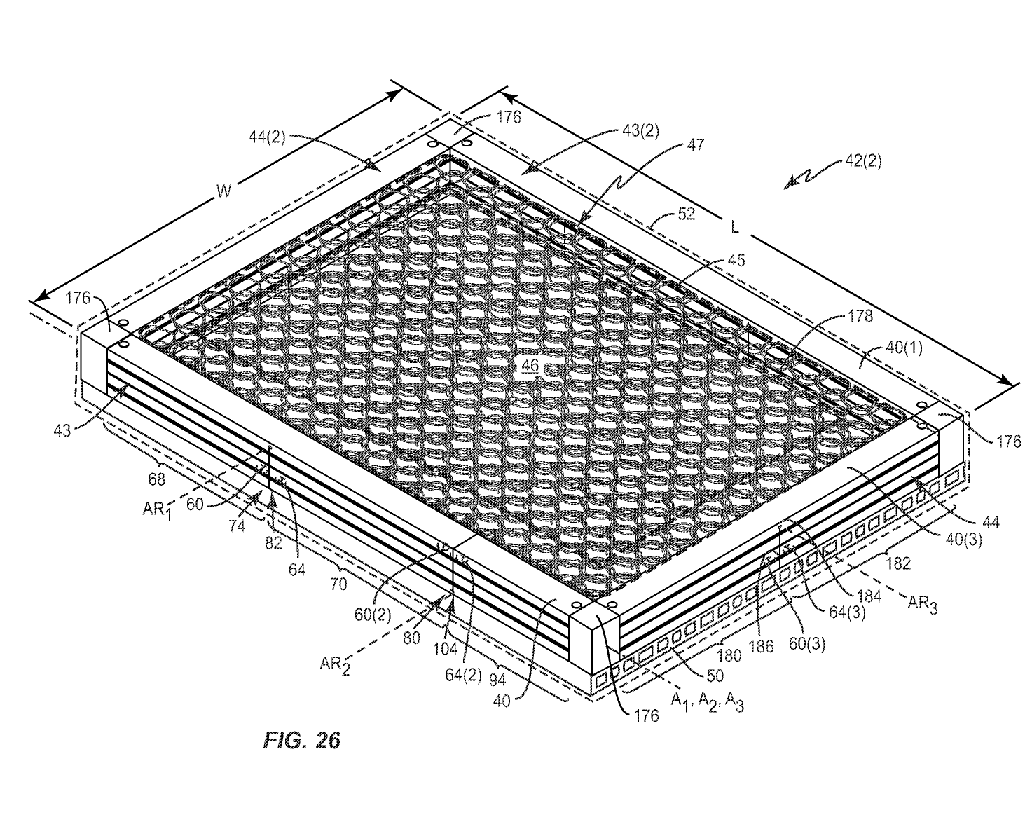

The elongated edge-support member 40 may be a side rail 43 as depicted in FIG. 2A or an end rail 44(2) as depicted later in FIG. 26. The side rail 43 may be orientated along the length L of the mattress and the end rail may be orientated along the width W of the mattress. The side rails 43 are nominally 71-inches long, except for a full-size mattress which may be 66-inches and a California king-size mattress may have the side rail 43 which may be 75-inches long. The second elongated edge-support member section 70 of the side rails may be 29-inches for all mattress sizes to permit uniform storage and/or transport before final assembly into the mattress assembly 42. However, the first elongated edge-support member section 68 of the side rail 43 depends on mattress type, for example, all mattress sizes may be nominally 16-inches, except for the full-size which may be 13.5-inches and the California king-size which may be 18-inches.

Moreover, the lengths of the end rails 44(2) of the twin XL, full, queen, EX queen, king, and California king-sized mattresses may be 29, 45, 51, 57, 67, and 63-inches respectively. The lengths of the first elongated edge-support member section 68 for the end rail of the full, queen, EX queen, king, and California king-sized mattresses may be 22.5, 25.5, 28.5, 33.5, and 31.5-inches respectively. The end rail 44(2) of the twin XL-sized mattress may not be defined into a first and second elongated edge-support member sections 68, 70 because the end rail 44(2) may not be long enough to benefit from being secured by magnet attraction. For example, the end rail of the twin-XL-sized mattress may be 29-inches which is the same length as the length of the second elongated edge-support member sections 70 of the other mattress sizes, so there may be a benefit in making 29-inches the standard size to simplify transportation and storage for facilities accommodating multiple mattress sizes.

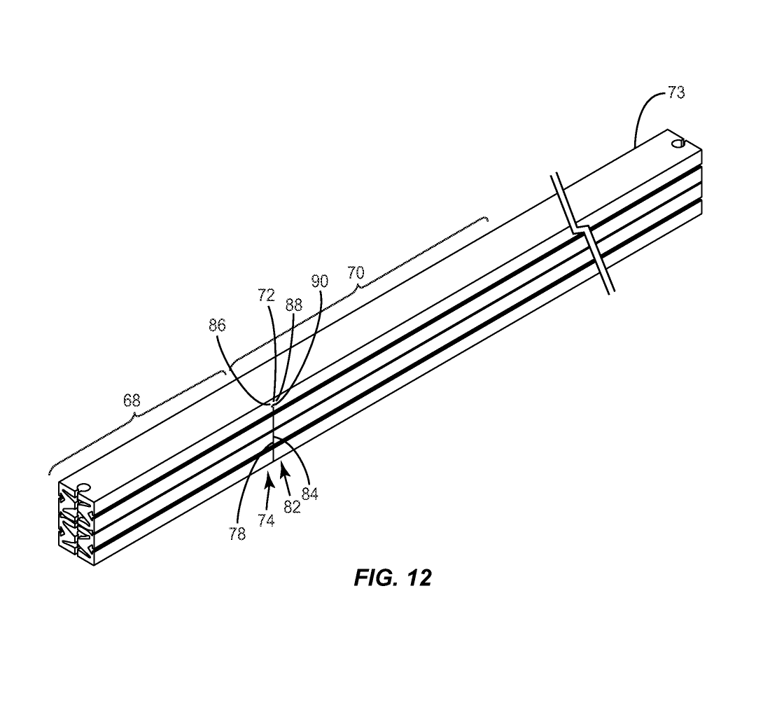

Next, as depicted in FIG. 12, material may be removed between the first end 74 of the first elongated edge-support member section 68 and the second end 82 of the second elongated edge-support member section 70 (step 146 in FIG. 10). The removal of material may occur via an articulated cut involving the application of heat or a sharp cut to the elongated member 73. The removal of material may form the first end surface 78 of the first end 74 of the first elongated edge-support member section 68, and the second end surface 84 of the second end 82 of the second elongated edge-support member section 70. The removal of material may also form the first connection 72 between the portion 86 of the first end 74 of the first elongated edge-support member section 68 and the portion 88 of the second end 82 of the second elongated edge-support member section 70. The removal of material may also create the a rounded surface 90 in contact with the first end surface 78 of the first elongated edge-support member section 68 and the second end surface 84 of the second elongated edge-support member section 70. The rounded surface 90 may prevent tearing. The removal of material may optionally not include creating the rounded surface 90 to reduce manufacturing expense.

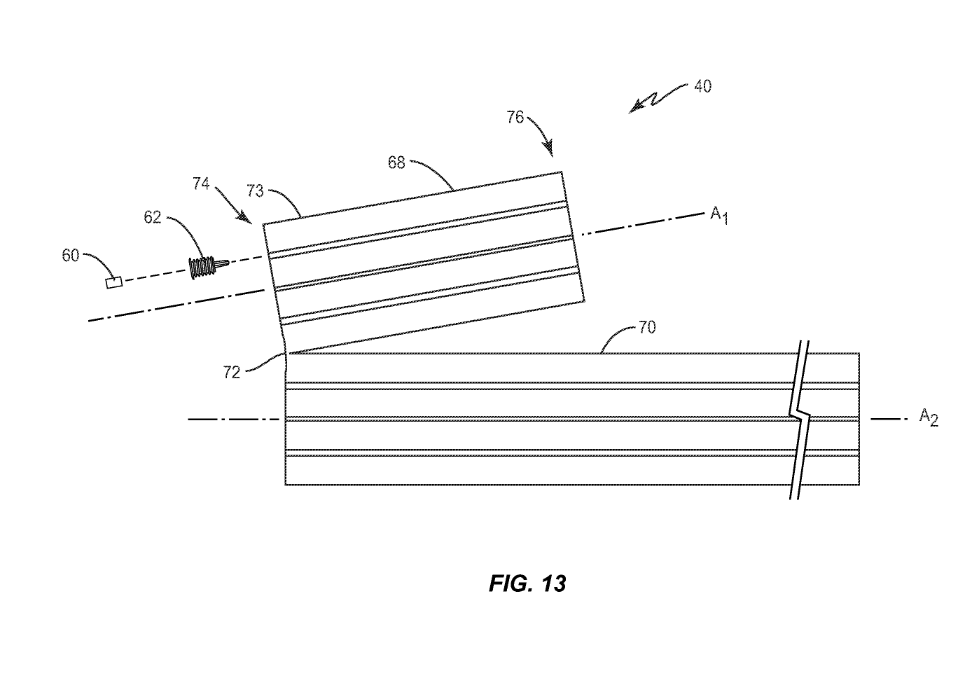

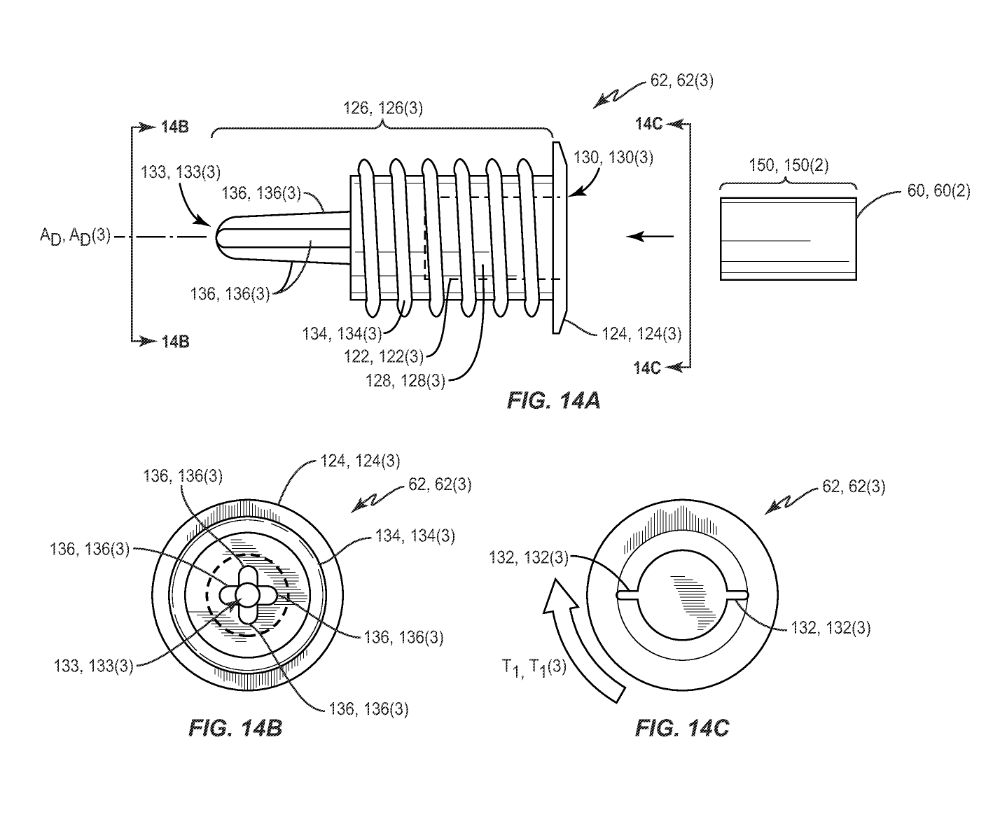

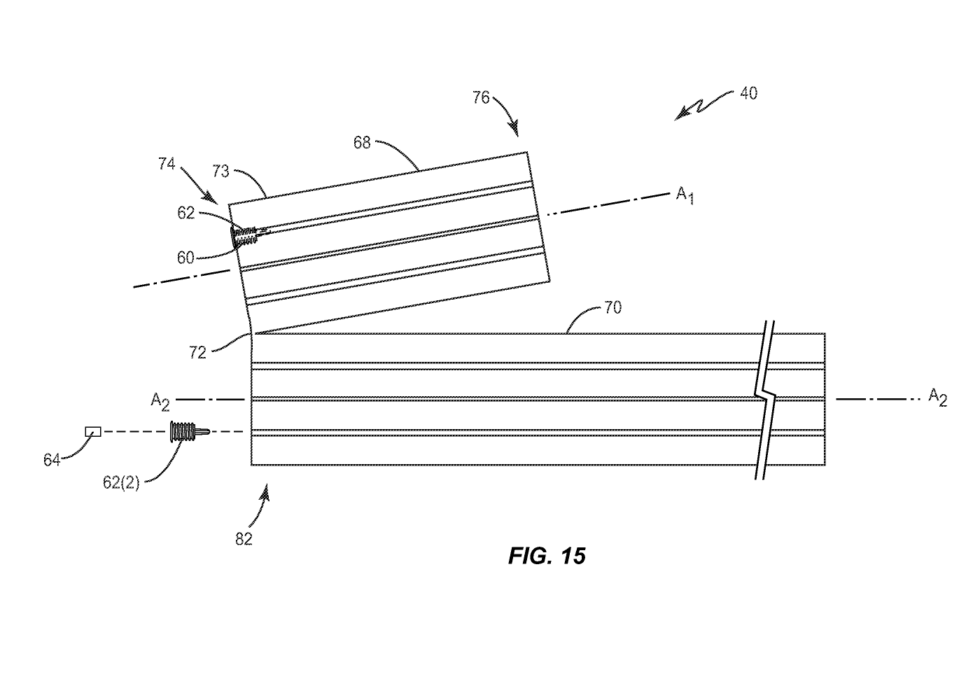

Next, as depicted in FIG. 13, the magnet 60 may be disposed in the first end 74 of the first elongated edge-support member section 68 (step 148 in FIG. 10). The disposing the magnet 60 into the first end 74 of the first elongated edge-support member section 68 may further include disposing at least a portion 150 of the magnet 60 into the insertion orifice 130 to the internal cavity 128 of the enclosure 122 of the attachment device 62 as shown in FIG. 14A through 14C. The attachment device 62 may include the head 124 having the insertion orifice 130. Then, the exterior helical thread 134 of the shank 126 may be screwed into the first end 74 of the first elongated edge-support member section 68. The shank 126 may be screwed into the first end 74 of the first elongated edge-support member section 68 by having the fastener interface surfaces 132 of the head 124 receive torque T₁ from the fastening device. The shank 126 may be screwed into the first end 74 until the magnet 60 may be fully disposed within the first elongated edge-support member section 68.

The fastener interface surfaces 132 may be parallel to the device longitudinal axis A_{D}. The shank 126 may extend from the head 124 to the distal end 133 along the device longitudinal axis A_{D}. The shank 126 may be tapered. The exterior helical thread 134 may be disposed in the spiral around the device longitudinal axis A_{D}. While screwing the exterior helical thread 134 of the shank 126 into the first end 74 of the first elongated edge-support member section 68, the radial protrusions 136 attached to the attachment device 62 at the distal end 133 of the shank 126 may be screwed into the first end 74 of the first elongated edge-support member section 68. The radial protrusions 136 may help the attachment device 62 from detaching from the elongated member 73.

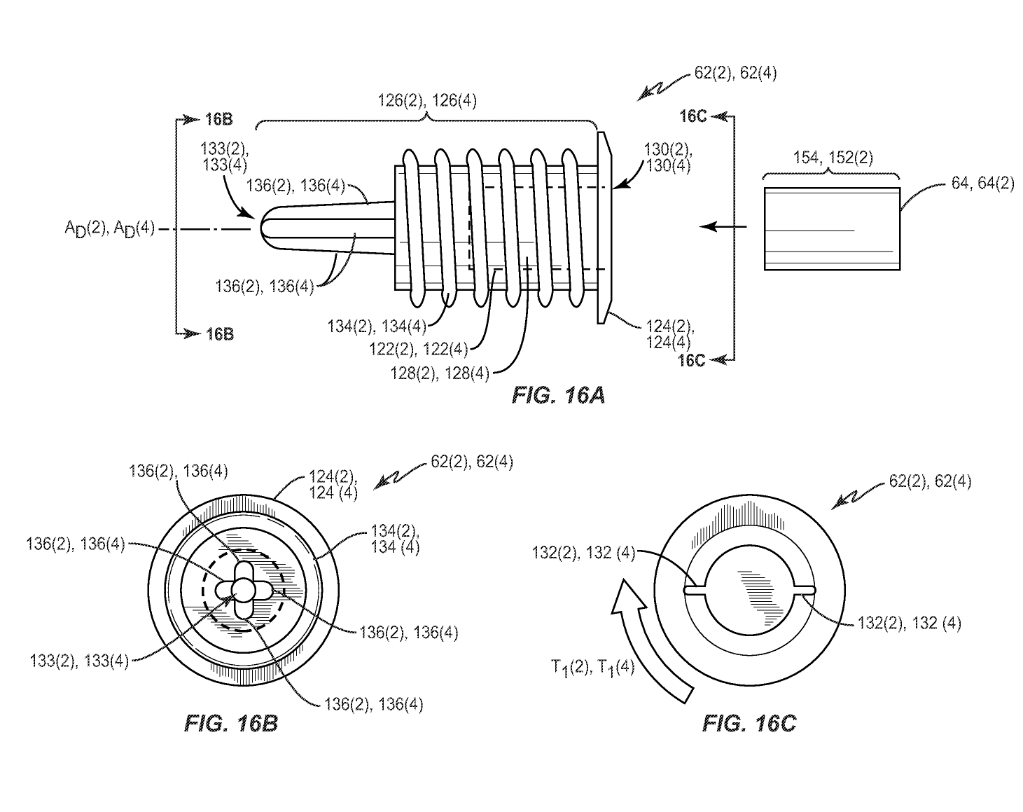

Next, as depicted in FIG. 15, the magnetic attractive member 64 may be disposed in the second end 82 of the second elongated edge-support member section 70 (step 152 in FIG. 10). The magnetic attractive member 64 may comprise at least one magnet and/or a ferrous material. The disposing the magnetic attractive member 64 into the second end 82 of the second elongated edge-support member section 70 may further comprise disposing at least a portion 154 of the magnetic attractive member 64 through the insertion orifice 130(2) to the internal cavity 128(2) of the enclosure 122(2) of the attachment device 62(2) as shown in FIGS. 16A through 16C. The attachment device 62(2) may include the head 124(2) including the insertion orifice 130(2). Then, the exterior helical thread 134(2) of the shank 126(2) may be screwed into the second end 82 of the second elongated edge-support member section 70. The shank 126(2) may extend from the head 124(2) to the distal end 133(2) along the device longitudinal axis A_{D}(2). The shank 126(2) may be screwed into the second end 82 of the second elongated edge-support member section 70 by having the fastener interface surfaces 132(2) of the head 124(2) receive a second torque T₁(2) from the fastening device. The shank 126(2) may be screwed into the second end 82 until the magnetic attractive member 64 may be fully disposed within the second elongated edge-support member section 70. The fastener interface surfaces 132(2) may be parallel to the device longitudinal axis A_{D}. The shank 126(2) may extend from the head 124(2) to the distal end 133(2) along the device longitudinal axis A_{D}(2). The shank 126(2) may be tapered. The exterior helical thread 134(2) may be disposed in a spiral around the device longitudinal axis A_{D}(2). While screwing the exterior helical thread 134(2) of the shank 126(2) into the second end 82 of the second elongated edge-support member section 70, the radial protrusions 136(2) attached to the attachment device 62(2) at the distal end 133(2) of the shank 126(2) may be screwed into the second end 82 of the second elongated edge-support member section 70.

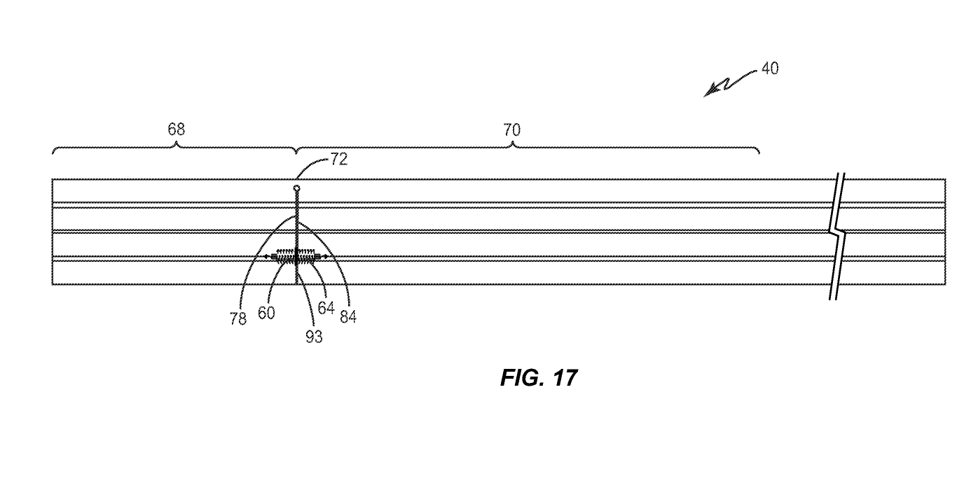

Next, as depicted in FIG. 17, the first elongated edge-support member section 68 and the second elongated edge-support member section 70 may be aligned in the first configuration by aligning the first end surface 78 of the first elongated edge-support member section 68 and the second end surface 84 of the second elongated edge-support member section 70 with the attraction force 93 (step 158 in FIG. 10). The attraction force 93 may be disposed between the magnet 60 and the magnetic attractive member 64. The attraction force 93 may abut the first end surface 78 of the first elongated edge-support member section 68 and the second end surface 84 of the second elongated edge-support member section 70 as also shown in FIG. 17.

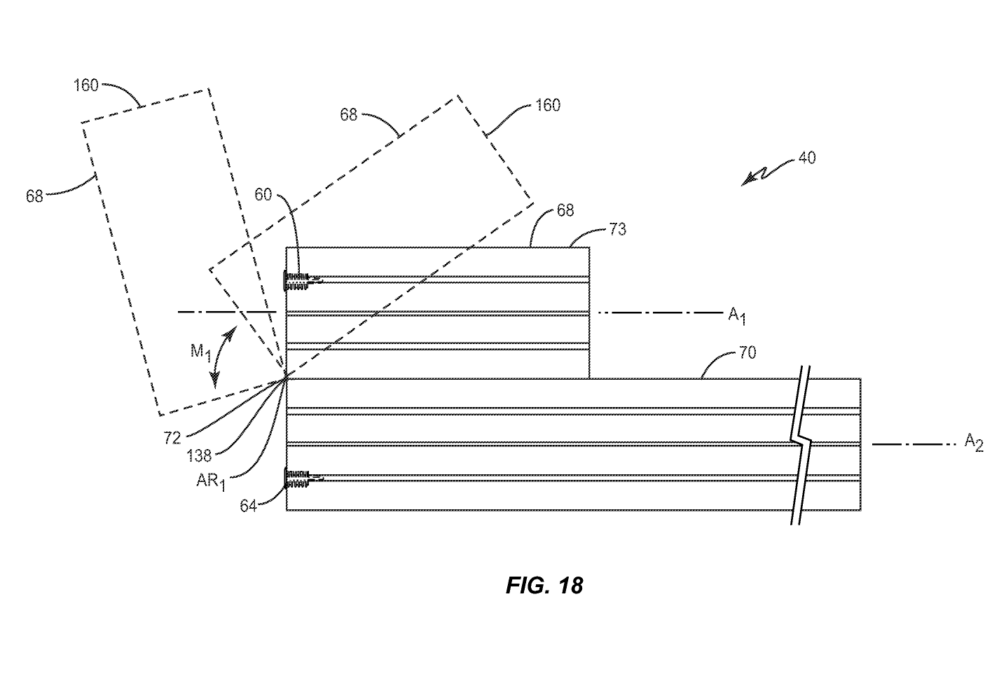

In FIG. 18 the elongated edge-support member 40 may be tested temporarily to ensure the hinge 138 can be converted to the second configuration more compact for storage and transportation. As depicted in FIG. 18, a moment M₁ may be applied to the first connection 72 to remove the second elongated edge-support member section 70 from alignment with respect to the first longitudinal axis A₁ to create the second configuration. As discussed earlier, the second configuration may be used for storage or transportation of the elongated edge-support member 40 before the final assembly into a mattress assembly 42. The moment M₁ may be applied, for example, by holding the second elongated edge-support member section 70 stationary while moving the first elongated edge-support member section 68 with enough force to overcome the attraction force 93. While applying the moment M₁, the first elongated edge-support member section 68 may be moved through rotational positions 160 relative to the second elongated edge-support member section 70 about the hinge 138 having the first axis of rotation AR₁. The hinge 138 may be included as part of the first connection 72 which may operatively connect the second elongated edge-support member section 70 and the first elongated edge-support member section 68. The first connection 72 may be a living hinge.

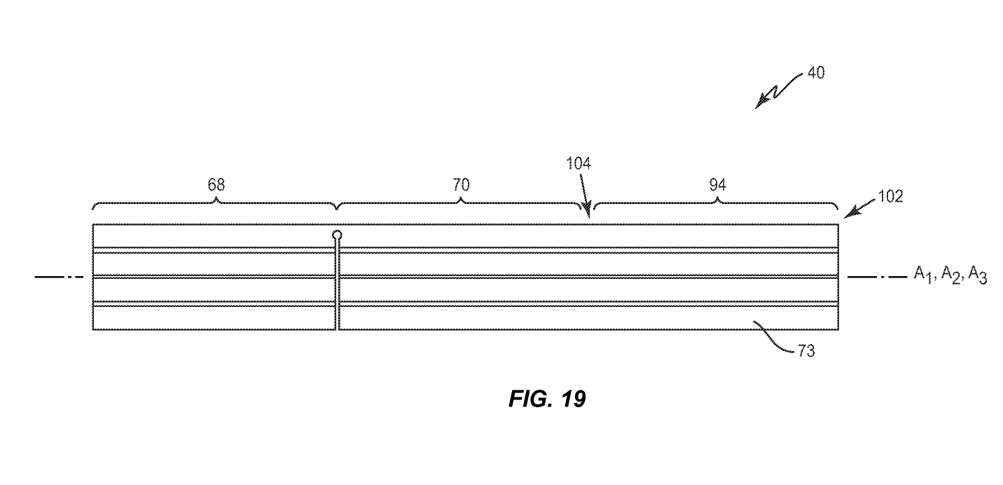

Next, as depicted in FIG. 19, the third elongated edge-support member section 94 may be defined (step 162 in FIG. 10). The third elongated edge-support member section 94 may be needed for side rails, but generally not for end rails which are generally shorter in length. The third elongated edge-support member section 94 may include the first end 102 and the second end 104 disposed along the third longitudinal axis A₃. The defining may include measuring the correct lengths for the third elongated edge-support member section 94. The third elongated edge-support member section 94 may be nominally 26-inches in length for most mattresses sizes, except the full-size mattress and the California king-size which may have the third elongated edge-support member section 94 lengths of 23.5-inches and 28-inches respectively.

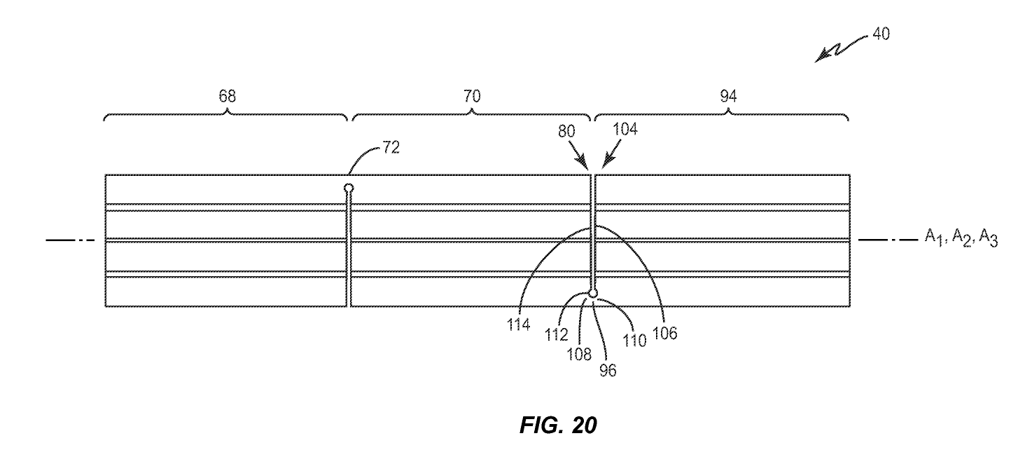

Next, as depicted in FIG. 20, material may be removed between the first end 80 of the second elongated edge-support member section 70 and the second end 104 of the third elongated edge-support member section 94 (step 164 in FIG. 10). The removal of material may occur via an articulated cut involving an application of heat or a sharp cut to the elongated member 73. The removal of material may form the first end surface 114 of the first end 80 of the second elongated edge-support member section 70, and the second end surface 106 of the second end 104 of the third elongated edge-support member section 94. The removal of material may also form the second connection 96 between the portion 108 of the first end 80 of the second elongated edge-support member section 70, and the portion 110 of the second end 104 of the third elongated edge-support member section 94. The removal of material may also create a second rounded surface 112(2) in contact with the first end surface 114 of the second elongated edge-support member section 70 and the second end surface 106 of the third elongated edge-support member section 94. The second rounded surface 112(2) may prevent tearing.

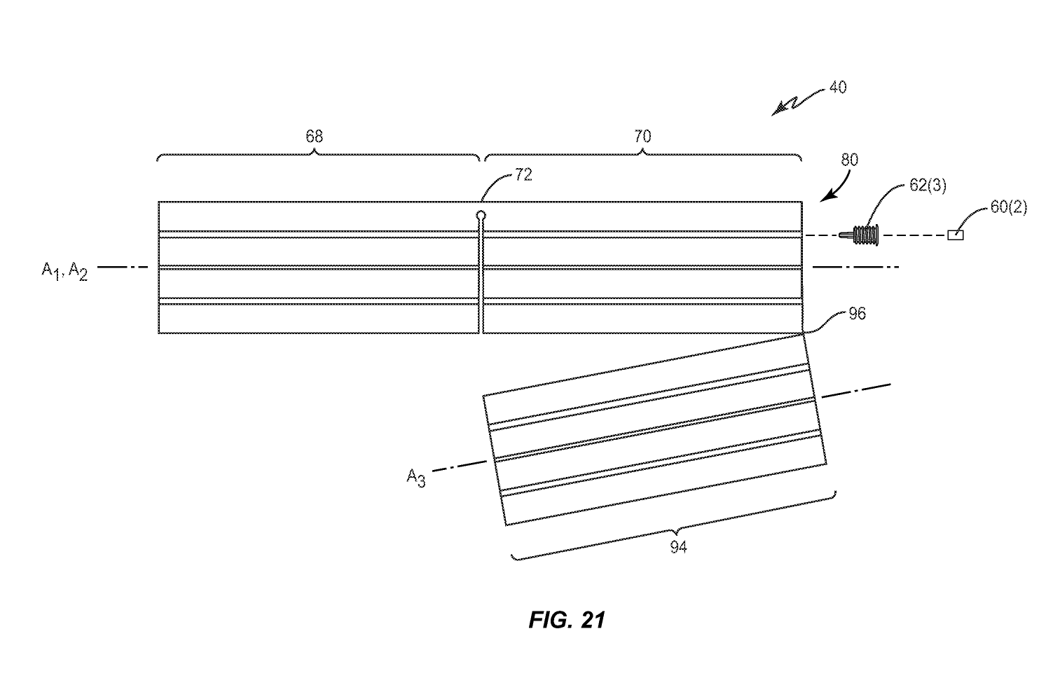

Next, as depicted in FIG. 21, the second magnet 60(2) may be disposed in the first end 80 of the second elongated edge-support member section 70 (step 166 in FIG. 10). The disposing the second magnet 60(2) into the first end 80 of the second elongated edge-support member section 70 may further comprise disposing at least the portion 150(2) of the second magnet 60(2) through the insertion orifice 130(3) to the internal cavity 128(3) of the enclosure 122(3) of the attachment device 62(3) as shown in FIGS. 14A to 14C. The attachment device 62(3) may include the head 124(3) including the insertion orifice 130(3). Then, the exterior helical thread 134(3) of the shank 126(3) may be screwed into the first end 80 of the second elongated edge-support member section 70. The shank 126(3) may be screwed into the first end 80 of the second elongated edge-support member section 70 by having the fastener interface surfaces 132(3) of the head 124(3) receive torque T₁(3) from the fastening device. The shank 126(3) may be screwed until the second magnet 60(2) may be fully disposed within the second elongated edge-support member section 70. The fastener interface surfaces 132(3) may be parallel to the device longitudinal axis A_{D}(3). The shank 126(3) may extend from the head 124(3) to the distal end 133(3) along the device longitudinal axis A_{D}(3). The shank 126(3) may be tapered. The exterior helical thread 134(3) may be disposed in the spiral around the device longitudinal axis A_{D}(3). While screwing the exterior helical thread 134(3) of the shank 126(3) into the first end 80 of the second elongated edge-support member section 70, the radial protrusions 136(3) attached to the attachment device 62(3) at the distal end 133(3) of the shank 126(3) may be screwed into the first end 80 of the second elongated edge-support member section 70.

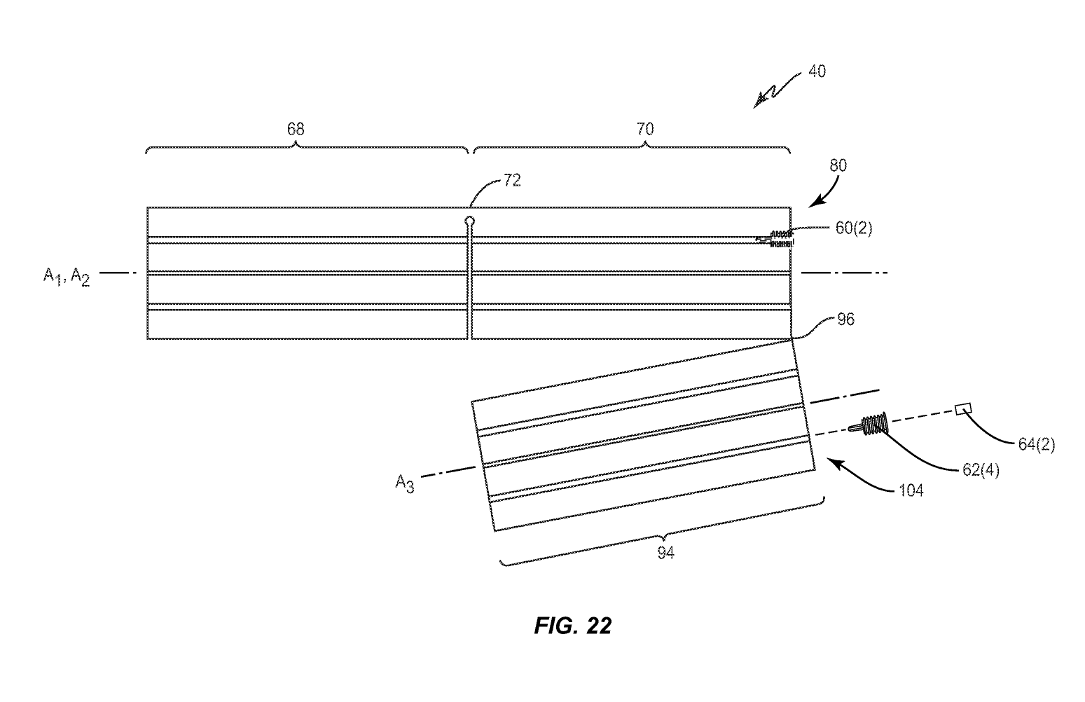

Next, as depicted in FIG. 22, the second magnetic attractive member 64(2) may be disposed in the second end 104 of the third elongated edge-support member section 94 (step 168 in FIG. 10). The second magnetic attractive member 64(2) may comprise at least one magnet and/or a ferrous material. The disposing the second magnetic attractive member 64(2) into the second end 104 of the third elongated edge-support member section 94 may further comprise disposing at least a portion 154(2) of the second magnetic attractive member 64(2) through the insertion orifice 130(4) to the internal cavity 128(4) of the enclosure 122(4) of the attachment device 62(4) as shown previously in FIG. 16A through 16C. The attachment device 62(4) may include the head 124(4) including the insertion orifice 130(4). Next, the exterior helical thread 134(4) of the shank 126(4) may be screwed into the second end 104 of the third elongated edge-support member section 94. The shank 126(4) may extend from the head 124(4) to the distal end 133(4) along the device longitudinal axis A_{D}(4). The shank 126(4) may be screwed into the second end 104 of the third elongated edge-support member section 94 by having the fastener interface surfaces 132(4) of the head 124(4) receive torque T₁(4) from the fastening device. The shank 126(4) may be screwed into the second end 104 until the second magnetic attractive member 64(2) may be fully disposed within the third elongated edge-support member section 94. The fastener interface surfaces 132(4) may be parallel to the device longitudinal axis A_{D}. The shank 126(4) may extend from the head 124(4) to the distal end 133(4) along the device longitudinal axis A_{D}(4). The shank 126(4) may be tapered. The exterior helical thread 134(4) may be disposed in a spiral around the device longitudinal axis A_{D}(4). While screwing the exterior helical thread 134(4) of the shank 126(4) into the second end 104 of the third elongated edge-support member section 94, the radial protrusions 136(4) attached to the attachment device 62(4) at the distal end 133(4) of the shank 126(4) may be screwed into the second end 104 of the third elongated edge-support member section 94.

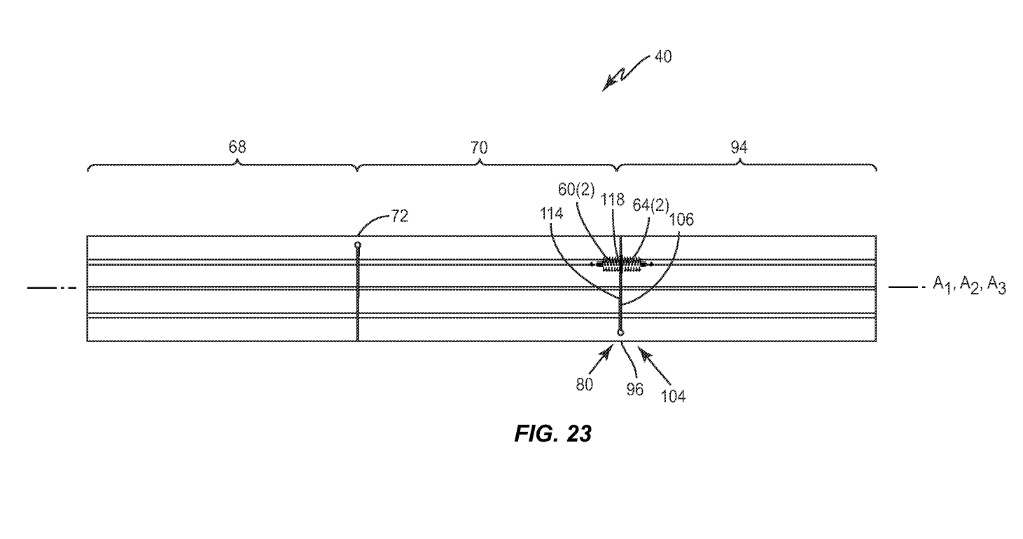

Next, as depicted in FIG. 23, the second elongated edge-support member section 70 and the third elongated edge-support member section 94 may be aligned in the first configuration by aligning the first end surface 114 of the second elongated edge-support member section 70 and the second end surface 106 of the third elongated edge-support member section 94 with the second attraction force 118 (step 172 in FIG. 10). The second attraction force 118 may be disposed between the second magnet 60(2) and the second magnetic attractive member 64(2). The second attraction force 118 may further abut the first end surface 114 of the second elongated edge-support member section 70 and the second end surface 106 of the third elongated edge-support member section 94 as also shown in FIG. 23. The elongated edge-support member 40 is now in the first configuration ready for inclusion in the mattress assembly 42 as depicted in the final completed version in FIG. 2A.

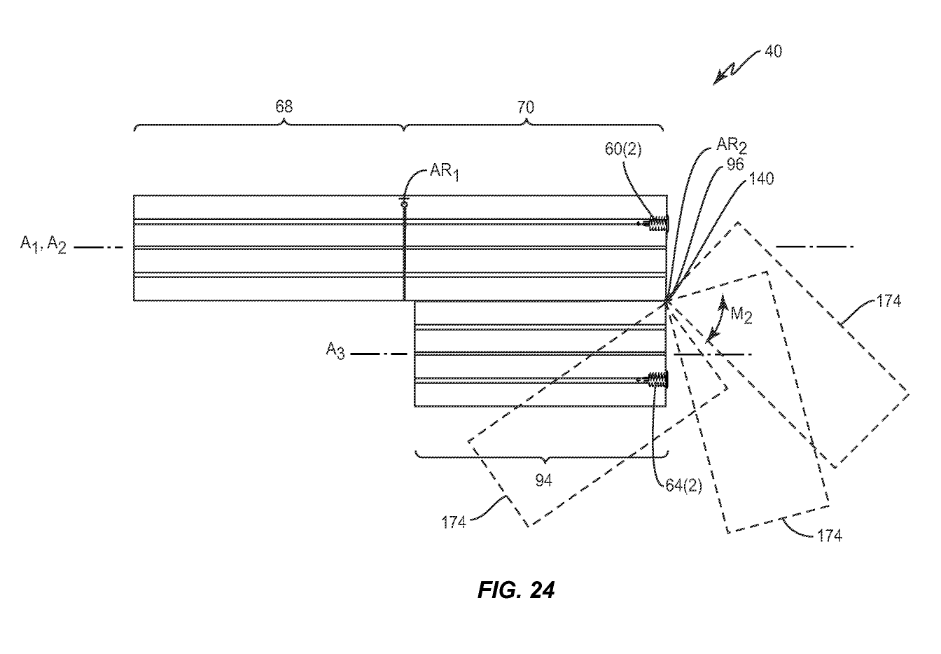

If the elongated edge-support member is to be stored or transported prior to inclusion in the mattress assembly 42, then it may be converted to the second configuration more compact for storage or transportation. As depicted earlier the moment M₁ may be applied to the first connection 72 to convert the first connection 72 to the second configuration. As depicted in FIG. 24, a moment M₂ may be applied to the second connection 96 to remove the third elongated edge-support member section 94 from alignment with respect to the second longitudinal axis A₂ and thereby create the second configuration as shown in FIGS. 9A and 9B. As discussed earlier, the second configuration may be used for storage or transportation before the final assembly into a mattress assembly 42. The moment M₂ may be applied, for example, by holding the second elongated edge-support member section 70 stationary while moving the third elongated edge-support member section 94 with enough force to overcome the second attraction force 118. While applying the moment M₂, the third elongated edge-support member section 94 may be moved through second rotational positions 174 relative to the second elongated edge-support member section 70 about the second hinge 140 having the second axis of rotation AR₂. The second hinge 140 may be included as part of the second connection 96 which may operatively connect the second elongated edge-support member section 70 and the first elongated edge-support member section 68. The second connection 96 may be a living hinge.

The method may be readily modified into two different embodiments. In the first embodiment as shown in FIG. 24, the first axis of rotation AR₁ and the second axis of rotation AR₂ may be parallel. As a result, the elongated edge-support member 40 may have a minimum cross sectional dimension in the second configuration (see FIG. 9B), whereas the second elongated edge-support member section 70 may be completely disposed between the first elongated edge-support member section 68 and the third elongated edge-support member section 94. The advantage of this first embodiment is easier storage and/or transportation prior to final assembly into the mattress assembly 42.

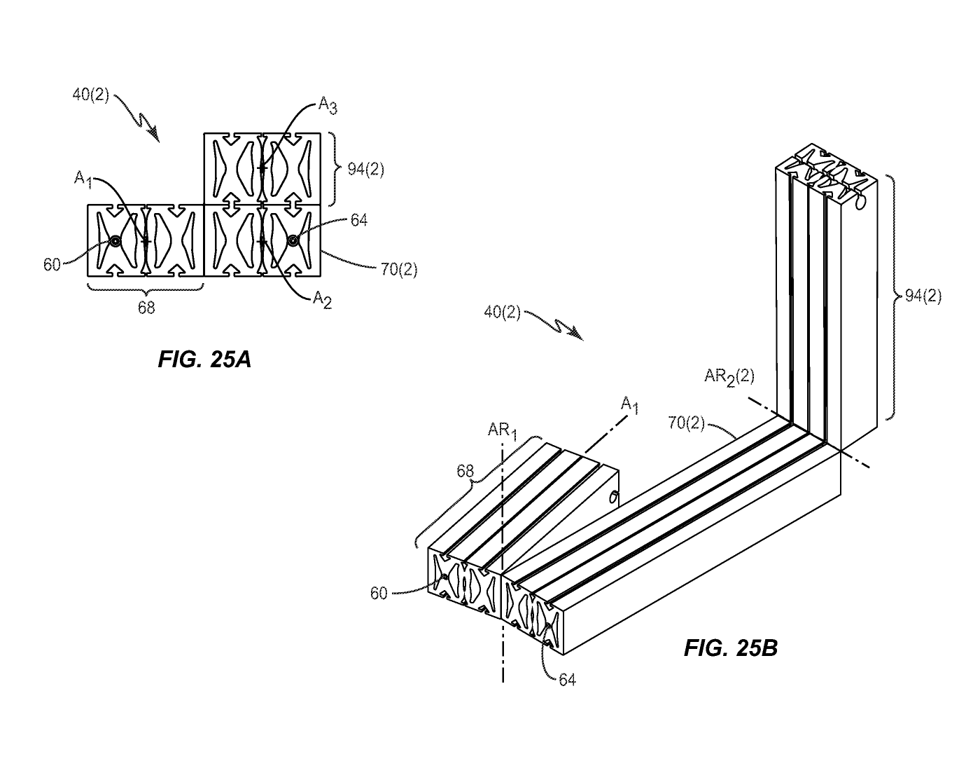

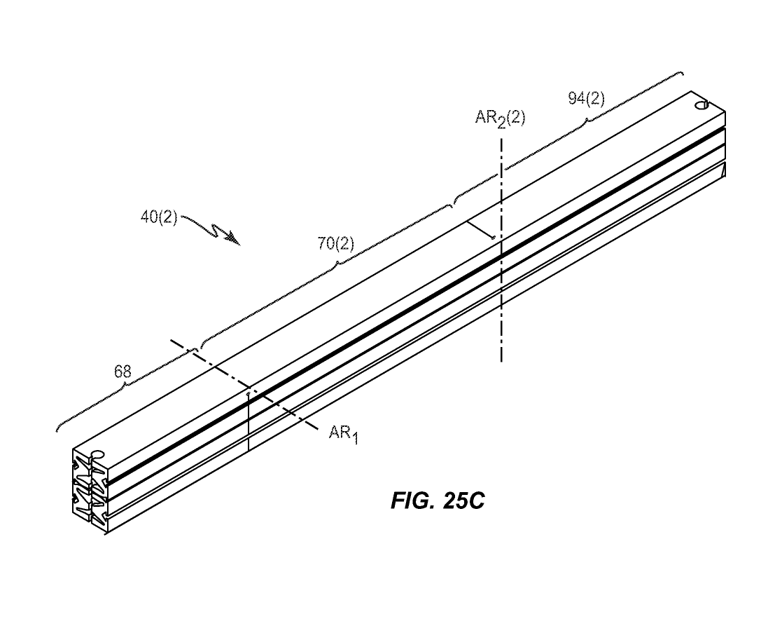

Alternatively, an elongated edge-support member 40(2) may be needed that has a second configuration that is shorter than the first configuration to provide ease of transportation and/or storage, but in addition has a more compact cross section than the cross section in FIG. 9B. In this regard, a second embodiment as depicted in FIG. 25A may include the elongated edge-support member 40(2). In this embodiment, the first longitudinal axis A₁, the second longitudinal axis A₂, and the third longitudinal axis A₃ may be parallel and not in alignment in the second configuration. Moreover, the second elongated edge-support member section 70(2) may not be completely disposed between the first elongated edge-support member section 68 and the third elongated edge-support member section 94(2) in this second configuration. Further, as depicted in FIGS. 25A through 25C, the first axis of rotation AR₁ and the second axis of rotation AR₂(2) may not be parallel.

Embodiments of the various elongated edge-support member 40 may be used in various locations in a mattress. FIG. 26 depicts an exemplary mattress assembly 42(2) which may include the elongated edge-support member 40 in the form of the side rail 43 and the elongated edge-support member 40(3) in the form of the end rail 44, all in the first configuration. The elongated edge-support member 40(3) may have two elongated edge-support sections 180, 182 connected by a third connection 184. The third connection 184 may be a third hinge with a third axis of rotation AR₃. The two elongated edge-support sections 180, 182 may also be secured by a magnet 60(3) and a magnetic attractive member 64(3) creating an attractive force 186. The side rail 43 and the end rail 44 are attached to a corner member 176. The mattress may also include the end rail 44(2) and a side rail 43(2) with features similar to the end rail 44 and the side rail 43 respectively. The side rails 43 and 43(2) and the end rails 44 and 44(2) may surround the outer perimeter 45 of the innerspring 46 and are connected at the corner members 176. A sleep surface 178 may be within the outer perimeter 45.

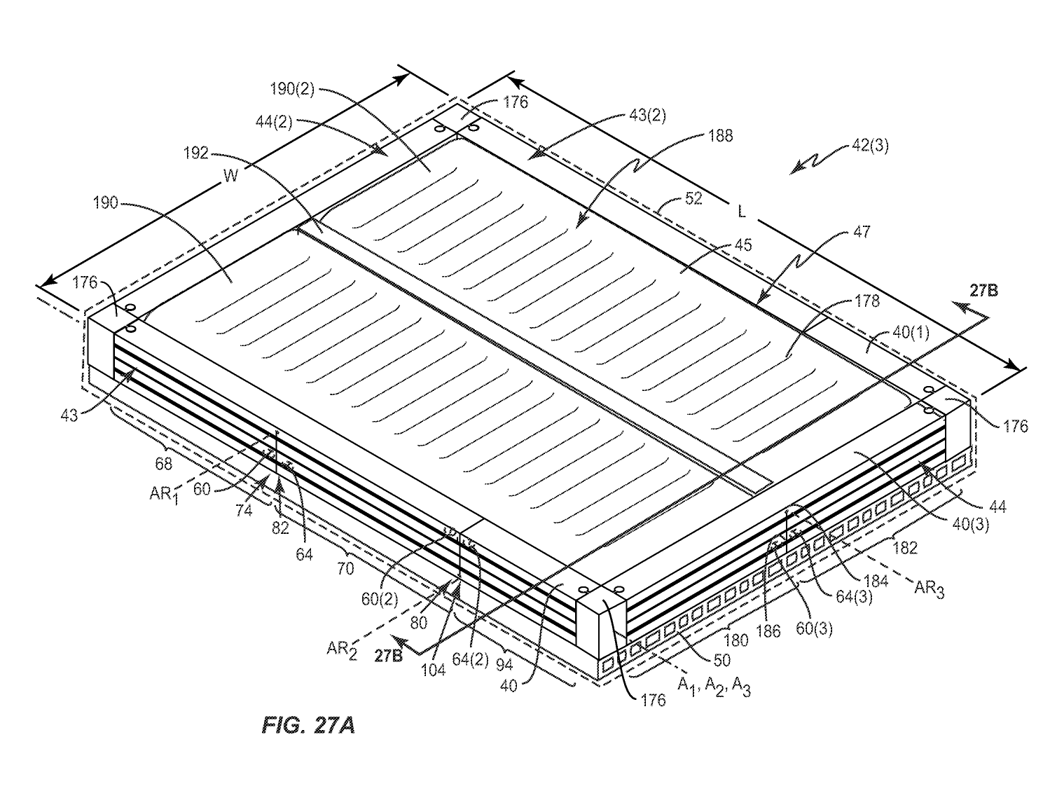

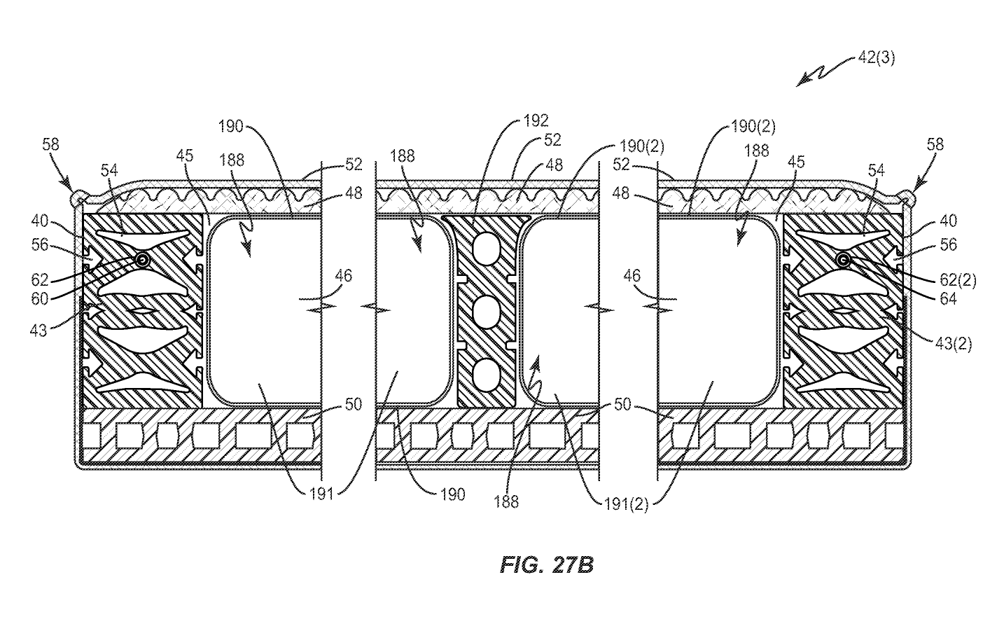

FIGS. 27A and 27B depict an alternative exemplary mattress assembly 42(3) which may be used with embodiments of the various elongated edge-support member 40, for example, those embodiments shown in FIG. 26 or any other embodiments disclosed herein. Specifically, the alternative exemplary mattress assembly 42(3) may include an embodiment where the mattress core 47 is at least one air bladder mattress core system 188. One embodiment of the at least one air bladder mattress core system 188 may be a first air bladder 190, a second air bladder 190(2), and a center wall support 192 as shown in FIG. 27A. The first air bladder 190 may be configured to contain air 191 and second air bladder 190(2) may be configured to contain air 191(2). The first air bladder 190 and second air bladder 190(2) may be made of a strong flexible material, for example, plastic, composite, or rubber configured to contain air. The center wall support 192 may be made of a strong flexible material, for example, thermoplastic. As shown in FIGS. 27A and 27B, the center wall support 192 may abut the first air bladder 190, the second air bladder 190(2), the end rails 44, 44(2), and the base 50. The side rails 43 and 43(2) and the end rails 44 and 44(2) may surround the outer perimeter 45 of the at least one air bladder mattress core system 188 and are connected at the corner members 176. The mattress assembly 42(3) may optionally not include upholstery 52 and padding material 48.

Embodiments disclosed herein are exemplary, and may be provided together in any combination desired. Based on this disclosure, mattress assemblies may be assembled using the elongated edge-support members employing magnets disclosed herein around any of a variety of mattress cores, including for example, air bladder mattress cores, innerspring coil mattress cores, pocketed coil spring mattress cores (e.g. Marshall coil mattress cores), and mattress cores formed from a cellular material (e.g. foam). Because each elongated edge-support member disclosed herein is adaptable to be disposed around a variety of types and dimensions of mattress cores, the embodiments disclosed herein enable mattress core manufacturers to more easily store and transport the elongated edge-support members.

Those skilled in the art will recognize improvements and modifications to the embodiments disclosed herein. For example, the magnet 60 may be disposed in the second end 82 of the second elongated edge-support member section 70 and the magnetic attractive member 64 may be disposed in the first end 74 of the first elongated edge-support member section 68. Another example is that the magnet 60, 60(2) and/or the magnetic attractive member 64, 64(2) may be disposed in the first, second, and/or third elongated edge-support member sections 68, 70, 94, without an attachment device 62, 62(2), 62(3), 62(4) by insertion perpendicular and/or parallel to the first second and/or third longitudinal axes A₁, A₂, A₃. Many modifications and other embodiments of the invention set forth herein will come to mind to one skilled in the art to which the invention pertains having benefit of the teachings presented in the foregoing descriptions and the associated drawings. These modifications include, but are not limited to the type of mattress core, elongated edge-support members, magnets, magnetic attractive members, attachment devices, and living hinges formed therein. Attachment devices can be included as part of the elongated edge-support member, but are optional and not required. The materials or compositions of the aforementioned components can be varied as well, including but not limited to whether exclusively thermoset or thermoplastic materials, or a composite of both. All such improvements and modifications are considered within the scope of the concepts disclosed herein.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art.

Further, it is to be understood that the embodiments are not limited to the specific embodiments disclosed and that modifications and other embodiments are intended to be included within the scope of the appended claims. It is intended that the embodiments cover the modifications and variations of this invention provided they come within the scope of the appended claims and their equivalents. Although specific terms are employed herein, they are used in a generic and descriptive sense only and not for purposes of limitation.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. An elongated edge-support member for a mattress assembly, comprising:
a first elongated edge-support member section comprising a first end and a second end disposed along a first longitudinal axis, the first end including a first end surface at least partially facing the first longitudinal axis;
a second elongated edge-support member section comprising a first end and a second end disposed along a second longitudinal axis, the second end including a second end surface at least partially facing the second longitudinal axis;
at least one magnet disposed in the first end of the first elongated edge-support member section;
at least one magnetic attractive member disposed in the second end of the second elongated edge-support member section; and
a first connection between a portion of the first end of the first elongated edge-support member section and a portion of the second end of the second elongated edge-support member section,
wherein in a first configuration, an attraction force disposed between the at least one magnet and the at least one magnetic attractive member aligns the first end surface with the second end surface, and aligns the first elongated edge-support member section and the second elongated edge-support member section along the first longitudinal axis.

2. The elongated edge-support member of claim 1, wherein in the first configuration the attraction force causes the first end surface of the first elongated edge-support member section to abut with the second end surface of the second elongated edge-support member section.

3. The elongated edge-support member of claim 1, wherein in a second configuration the second elongated edge-support member section is not in alignment with the first longitudinal axis.

4. The elongated edge-support member of claim 1, wherein the at least one magnetic attractive member comprises a magnet.

5. The elongated edge-support member of claim 1, wherein the at least one magnetic attractive member comprises a ferrous material.

6. The elongated edge-support member of claim 1, further comprising at least one attachment device attached to the first end of the first elongated edge-support member section, the at least one attachment device comprising:
an enclosure forming an internal cavity configured to contain at least a portion of the at least one magnet;
a head including an insertion orifice, the insertion orifice configured to allow a portion of the at least one magnet to enter the internal cavity through the insertion orifice; and
a shank extending from the head to a distal end along a device longitudinal axis, the shank including an exterior helical thread disposed in a spiral around the device longitudinal axis,
wherein the shank is disposed within the first end of the first elongated edge-support member section.

7. The elongated edge-support member of claim 6, further comprising at least one second attachment device attached to the second end of the second elongated edge-support member section, the at least one second attachment device comprising:
a second enclosure forming a second internal cavity configured to contain at least a portion of the at least one magnetic attractive member;
a second head including a second insertion orifice, the portion of the at least one magnetic attractive member configured to enter the second internal cavity through the second insertion orifice; and
a second shank extending from the second head to a second distal end along a second device longitudinal axis, the second shank including a second exterior helical thread disposed in a second spiral around the second device longitudinal axis,
wherein the second shank is disposed within the second end of the second elongated edge-support member section.

8. The elongated edge-support member of claim 1, wherein the first connection between the first elongated edge-support member section and the second elongated edge-support section comprises a hinge including a first axis of rotation, the hinge restricting the first elongated edge-support section to a plurality of rotational positions relative to the second elongated edge-support section about the first axis of rotation.

9. The elongated edge-support member of claim 8, further comprising:
a third elongated edge-support member section comprising a first end and a second end disposed along a third longitudinal axis, the second end of the third elongated edge-support member section including a second end surface at least partially facing the third longitudinal axis;
at least one second magnet disposed in the first end of the second elongated edge-support member section;
at least one second magnetic attractive member disposed in the second end of the second elongated edge-support member section; and
a second connection between a portion of the first end of the second elongated edge-support member section and a portion of the second end of the third elongated edge-support member section,
wherein the first end of the second elongated edge-support member section further comprises a first end surface at least partially facing the second longitudinal axis, and
wherein in the first configuration, a second attractive force between the at least one second magnet and the at least one second magnetic attractive member aligns the first end surface of the second elongated edge-support member section with the second end surface of the third elongated edge-support member section and aligns the third elongated edge-support member section with the second longitudinal axis.

10. The elongated edge-support member of claim 9, wherein the second attraction force causes the first end surface of the second elongated edge-support member section to abut with the second end surface of the third elongated edge-support member section.

11. The elongated edge-support member of claim 9, wherein in the second configuration the third elongated edge-support member section is not in alignment with the second longitudinal axis.

12. The elongated edge-support member of claim 9, further comprising at least one third attachment device attached to the first end of the second elongated edge-support member section, the at least one third attachment device comprising:
a third enclosure forming a third internal cavity configured to contain at least a portion of the at least one second magnet;
a third head including a third insertion orifice, the portion of the at least one second magnet configured to enter the third internal cavity through the third insertion orifice; and
a third shank extending from the third head to a third distal end along a third device longitudinal axis, the third shank including a third exterior helical thread disposed in a third spiral around the third device longitudinal axis,
wherein the third shank is disposed within the third elongated edge-support member section.

13. The elongated edge-support member of claim 12, further comprising at least one fourth attachment device attached to the second end of the third elongated edge-support member section, the at least one fourth attachment device comprising:
a fourth enclosure forming a fourth internal cavity configured to contain at least a portion of the at least one second magnetic attractive member;
a fourth head including a fourth insertion orifice, the portion of the at least one second magnetic attractive member configured to enter the fourth internal cavity through the fourth insertion orifice; and
a fourth shank extending from the fourth head to a fourth distal end along a fourth device longitudinal axis, the fourth shank including a fourth exterior helical thread disposed in a fourth spiral around the fourth device longitudinal axis,
wherein the fourth shank is disposed within the second end of the third elongated edge-support member section.

14. The elongated edge-support member of claim 8, wherein the second connection between the second elongated edge-support section and the third elongated edge-support section comprises a second hinge including a second axis of rotation, the second hinge restricting the third elongated edge-support section to a plurality of second rotational positions relative to the second elongated edge-support section about a second axis of rotation.

15. The elongated edge-support member of claim 14, wherein the second elongated edge-support member section comprises:
a first longitudinal surface including the first axis of rotation; and
a second longitudinal surface opposite the first longitudinal surface, the second longitudinal surface including the second axis of rotation,
wherein the first and the second axis of rotation are parallel.

16. The elongated edge-support member of claim 14, wherein in the second configuration the second elongated edge-support member section is disposed completely between the first elongated edge-support member section and the third elongated edge-support member section, and the first longitudinal axis, the second longitudinal axis, and the third longitudinal axis are parallel and not in alignment.

17. The elongated edge-support member of claim 15, wherein the first end surface of the first elongated edge-support member section and the second end surface of the second elongated edge-support member section are not orthogonal to the first longitudinal axis and the second longitudinal axis respectively.

18. The elongated edge-support member of claim 14, wherein the second elongated edge-support member section comprises:
a first longitudinal surface including the first axis of rotation; and a second longitudinal surface including the second axis of rotation,
wherein the first and the second axis of rotation are not parallel.

19. A method of creating and installing an elongated edge-support member for a mattress assembly, comprising:
defining a first elongated edge-support member section and a second elongated edge-support member section within an elongated member, the first elongated edge-support member section comprising a first end and a second end disposed along a first longitudinal axis, and the second elongated edge-support member section comprising a first end and a second end disposed along a second longitudinal axis;
removing material between the first end of the first elongated edge-support member section and the second end of the second elongated edge-support member section to form a first end surface of the first end of the first elongated edge-support member section, a second end surface of the second end of the second elongated edge-support member section, and a first connection between a portion of the first end of the first elongated edge-support member section and a portion of the second end of the second elongated edge-support member section;
disposing at least one magnet in the first end of the first elongated edge-support member section;
disposing at least one magnetic attractive member in the second end of the second elongated edge-support member section; and
aligning the second elongated edge-support member section with the first longitudinal axis in a first configuration by aligning the first end surface of the first elongated edge-support member section and the second end surface of the second elongated edge-support member section with an attraction force disposed between the at least one magnet and the at least one magnetic attractive member.

20. The method of claim 19, wherein aligning the second elongated edge-support member section with the first longitudinal axis further comprises:
abutting the first end surface of the first elongated edge-support member section against the second end surface of the second elongated edge-support member section with the attraction force.

21. The method of claim 20, further comprising applying a moment to the first connection to remove the second elongated edge-support member section from alignment with the first longitudinal axis to create a second configuration.

22. The method of claim 21, wherein the applying the moment to the first connection further comprises moving the first elongated edge-support section through a plurality of rotational positions relative to the second elongated edge-support section about a hinge having a first axis of rotation, the hinge is included as part of the first connection which operatively connects the second elongated edge-support section and the first elongated edge-support section.

23. The method of claim 22, further comprising:
defining a third elongated edge-support member section within the elongated member, the third elongated edge-support member section comprising a first end and a second end disposed along a third longitudinal axis;
removing material between the first end of the second elongated edge-support member section and the second end of the third elongated edge-support member section to form a first end surface of the first end of the second elongated edge-support member section, a second end surface of the second end of the third elongated edge-support member section, and a second connection between a portion of the first end of the second elongated edge-support member section and a portion of the second end of the third elongated edge-support member section;
disposing at least one second magnet in the first end of the second elongated edge-support member section;
disposing at least one magnetic attractive member in the second end of the third elongated edge-support member section; and
aligning the second elongated edge-support member section and the third elongated edge-support member section in a first configuration by aligning the first end surface of the second elongated edge-support member section and the second end surface of the third elongated edge-support member section with a second attraction force between the at least one second magnet and the at least one second magnetic attractive member.

24. The method of claim 23, wherein aligning the second elongated edge-support member section and the third elongated edge-support member section in a first configuration, further comprises:
abutting the first end surface of the second elongated edge-support member section against the second end surface of the third elongated edge-support member section with the second attraction force.

25. The method of claim 24, further comprising applying a second moment to the second connection to remove the third elongated edge-support member section from alignment with the second longitudinal axis to create the second configuration.

26. The method of claim 25, wherein the applying the second moment to the second connection further comprises moving the third elongated edge-support section within a plurality of second rotational positions relative to the second elongated edge-support section about a second hinge having a second axis of rotation, wherein the second hinge is included as part of a second connection which operatively connects the second elongated edge-support section and the third elongated edge-support section.

27. The method of claim 26, wherein the first axis of rotation and the second axis of rotation are parallel.

28. The method of claim 26, wherein the first axis of rotation and the second axis of rotation are not parallel.

29. A mattress assembly, comprising a mattress core having an outer perimeter and a sleep surface disposed inside the outer perimeter, and an elongated edge-support member disposed along the outer perimeter of the mattress core, the elongated edge-support member comprising:
a first elongated edge-support member section comprising a first end and a second end disposed along a first longitudinal axis, the first end including a first end surface at least partially facing the first longitudinal axis;
a second elongated edge-support member section comprising a first end and a second end disposed along a second longitudinal axis, the second end including a second end surface at least partially facing the second longitudinal axis;
at least one magnet disposed in the first end of the first elongated edge-support member section;
at least one magnetic attractive member disposed in the second end of the second elongated edge-support member section; and
a first connection between a portion of the first end of the first elongated edge-support member section and a portion of the second end of the second elongated edge-support member section,
wherein in a first configuration, an attraction force disposed between the at least one magnet and the at least one magnetic attractive member aligns the first end surface with the second end surface, and aligns the first elongated edge-support member section and the second elongated edge-support member section along the first longitudinal axis.

30. The mattress assembly of claim 29, wherein the mattress core includes at least one air bladder configured to support at least a portion of a weight of a user.
